(19) United States
(12) Patent Application Publication
(10) Pub. No.: US 2022/0050367 A1
(43) Pub. Date: Feb. 17, 2022

(54) OPTICAL ELEMENT AND PROJECTION-TYPE DISPLAY DEVICE

(71) Applicant: SONY GROUP CORPORATION, TOKYO (JP)

(72) Inventor: SHOGO KUBOTA, TOKYO (JP)

(21) Appl. No.: 17/433,681

(22) PCT Filed: Jan. 15, 2020
(86) PCT No.: PCT/JP2020/001016

§ 371 Date: Aug. 25, 2021

(30) Foreign Application Priority Data
Mar. 5, 2019 (JP) 2019-039221

(51) Int. Cl. G03B 21/14; G02B 27/10; G02B 5/30

(52) U.S. Cl. CPC G03B 21/142; G03B 21/145; G02B 5/3083; G02B 27/1006

(57) ABSTRACT

A projection-type display device of the present disclosure includes: an optical element including a first polarization beam splitter (10), a retardation plate (50), and first changing means (63); and a first reflective spatial light modulator (40G), in which first light that has a first wavelength range and that has been emitted from a light source and has entered the first polarization beam splitter (10) via the first reflective spatial light modulator (40G) exits the first polarization beam splitter (10), passes through the retardation plate (50), and travels toward a projection optical system, and return light of the first light returning from the projection optical system passes through the retardation plate (50), enters the first polarization beam splitter (10), exits the first polarization beam splitter (10), and collides with the first changing means (63) to have the light path, the wavelength range, or the polarization state of the return light changed by the first changing means.

### TECHNICAL FIELD

The present disclosure relates to an optical element and a projection-type display device including such an optical element, and more particularly, to a projector.

### BACKGROUND ART

A three-panel projector that causes a light beam emitted from a light source to be modulated by a reflective liquid-crystal panel having a higher aperture ratio and higher definition than transmissive liquid-crystal panels and enlarges and projects the modulated light beam on a projection surface via a projection optical system is well known through, for example, Japanese Patent Application Laid-Open No. 2011-154381. The three-panel projector (projection-type image display device) includes:

(A) a first reflective liquid-crystal display element corresponding to light having a first wavelength region;

(B) a second reflective liquid-crystal display element corresponding to light having a second wavelength region different from the first wavelength region;

(C) a third reflective liquid-crystal display element corresponding to light having a green wavelength region different from the first and second wavelength regions;

(D) a projection optical system that projects the light from each of the first, second, and third reflective liquid-crystal display elements;

(E) a first polarization beam splitter that guides light of a first polarization direction included in the light having the first wavelength region received from a light source toward the first reflective liquid-crystal display element, guides light of a second polarization direction included in the light reflected by the first reflective liquid-crystal display element toward the projection optical system, the second polarization direction being perpendicular to the first polarization direction, guides light of the second polarization direction included in the light having the second wavelength region received from the light source toward the second reflective liquid-crystal display element, and guides light of the first polarization direction included in the light reflected by the second reflective liquid-crystal display element toward the projection optical system;

(F) a second polarization beam splitter that guides light of the first polarization direction included in the light having the green wavelength region received from the light source toward a third reflective liquid-crystal display element, and guides light of the second polarization direction included in the light reflected by the third reflective liquid-crystal display element toward the projection optical system;

(G) a wavelength-selective retardation plate, a first polarizing plate, an optical path combining element, and a quarter-wave plate that are disposed in the order mentioned from the first polarization beam splitter side between the first polarization beam splitter and the projection optical system, in which the wavelength-selective retardation plate rotates the polarization direction of the light having the first wavelength region by 90 degrees and does not rotate the polarization direction of the light having the second wavelength region,

the first polarizing plate blocks one of the light of the first polarization direction and the light of the second polarization direction from entering the projection optical system and guides the other one toward the projection optical system,

the optical-path combining element combines an optical path of the light exiting the first polarization beam splitter and an optical path of the light exiting the second polarization beam splitter, and guides the combined optical path toward the projection optical system, in which, with regard to the light having the green wavelength region among the light having the first, second, and green wavelength regions, the optical-path combining element either transmits the light of both the first polarization direction and the second polarization direction or reflects the light of both the first polarization direction and the second polarization direction; and

(H) a second polarizing plate that is disposed between the second polarization beam splitter and the optical-path combining element, blocks one of the light of the first polarization direction and the light of the second polarization direction from entering the projection optical system and guides the other one toward the projection optical system.

In addition, Japanese Patent Application Laid-Open No. 2011-154381 includes the following description in paragraph [0026]. That is, “for example, return light of the green light 18g reflected by the projection lens and returning is reflected in the P-polarized state by the color combining element 19, enters the polarizing plate 16A, and is absorbed by the polarizing plate 16A. Similarly, return light of 18r, 18b is absorbed by the polarizing plate 16B. In other words, return light reflected by a transmissive (boundary) plane of the projection lens is absorbed before reaching the panel surface. Consequently, return light of every light color component reflected by the projection lens and returning is absorbed by the polarizing plate without returning to the projection lens again. This reduces image deterioration (low contrast) on the screen attributable to light reflection on the projection lens.”

### CITATION LIST

### Patent Document

Patent Document 1: Japanese Patent Application Laid-Open No. 2011-154381

### SUMMARY OF THE INVENTION

### Problems to be Solved by the Invention

According to the technology disclosed in Japanese Patent Application Laid-Open No. 2011-154381, return light of every light color component is absorbed by a polarizing plate. Therefore, the technology is problematic in that significant heat is generated in the projector (projection-type image display device).

Accordingly, an object of the present disclosure is to provide a projection-type display device having a configuration and structure that achieve suppression of heat generation to the extent possible and an optical element suitable for use in such a projection-type display device.

### Solutions to Problems

An optical element according to a first aspect of the present disclosure intended to achieve the above-described object includes:

a polarization beam splitter; a retardation plate; and changing means, in which

light that has entered the polarization beam splitter from a light source exits the polarization beam splitter and passes through the retardation plate, and

return light that is the light that has passed through the retardation plate and has returned to the retardation plate passes through the retardation plate, enters the polarization beam splitter, exits the polarization beam splitter, and collides with the changing means to have the light path, the wavelength range, or the polarization state of the return light changed by the changing means.

A projection-type display device of the present disclosure intended to achieve the above-described object includes:

an optical element including a first polarization beam splitter, a retardation plate, and first changing means; and

a first reflective spatial light modulator, in which

first light that has a first wavelength range and that has been emitted from a light source and has entered the first polarization beam splitter via the first reflective spatial light modulator exits the first polarization beam splitter, passes through the retardation plate, and travels toward a projection optical system, and

return light of the first light returning from the projection optical system passes through the retardation plate, enters the first polarization beam splitter, exits the first polarization beam splitter, and collides with the first changing means to have the light path, the wavelength range, or the polarization state of the return light changed by the first changing means.

An optical element according to a second aspect of the present disclosure intended to achieve the above-described object includes:

a polarization beam splitter; a retardation plate; and changing means, in which

light that has entered the polarization beam splitter from a light source exits the polarization beam splitter and passes through the retardation plate, and

return light that is the light that has passed through the retardation plate and has returned to the retardation plate passes through the retardation plate, enters the polarization beam splitter, exits the polarization beam splitter, and is absorbed by a heat absorbing member.

### BRIEF DESCRIPTION OF DRAWINGS

FIGS. 1A and 1B are conceptual diagrams of an optical element of Example 1, and Modification 1 of the optical element of Example 1, respectively.

FIGS. 2A and 2B are conceptual diagrams of Modification 2 and Modification 3, respectively, of the optical element of Example 1.

FIGS. 3A and 3B are conceptual diagrams of Modification 4 and Modification 5, respectively, of the optical element of Example 1.

FIG. 4 is a conceptual diagram of an optical element of Example 2.

FIG. 5 is a conceptual diagram of the optical element of Example 2.

FIGS. 6A and 6B are conceptual diagrams of an optical element of Example 3.

FIG. 7 is a conceptual diagram of a projection-type display device of Example 4.

FIGS. 8A and 8B are conceptual diagrams showing enlarged views of part of the projection-type display device of Example 4 and Modification 6 of the projection-type display device of Example 4, respectively.

FIG. 9 is a conceptual diagram of Modification 1 of the projection-type display device of Example 4.

FIG. 10 is a conceptual diagram of Modification 2 of the projection-type display device of Example 4.

FIG. 11 is a conceptual diagram of Modification 3 of the projection-type display device of Example 4.

FIG. 12 is a conceptual diagram of Modification 4 of the projection-type display device of Example 4.

FIG. 13 is a conceptual diagram of Modification 5 of the projection-type display device of Example 4.

FIG. 14 is a conceptual diagram of a projection-type display device of Example 5 (a modification of Modification 4 of Example 4).

FIG. 15 is a conceptual diagram of the projection-type display device of Example 5 (a modification of Modification 4 of Example 4).

FIG. 16 is a conceptual diagram of still another modification of the projection-type display device of Example 5.

FIG. 17 is a conceptual diagram of Modification 7 of the projection-type display device of Example 4.

### MODE FOR CARRYING OUT THE INVENTION

The present disclosure will now be described on the basis of examples and with reference to the drawings; however, the present disclosure is not limited to the examples, and various numerical values and materials in the examples are illustrative examples. Note that descriptions will be provided in the order mentioned below.

1. General description of optical element according to first and second aspects of the present disclosure and projection-type display device of the present disclosure as a whole

2. Example 1 (optical element according to first aspect of the present disclosure)

3. Example 2 (modification of optical element of Example 1, projection-type display device of the present disclosure, projection-type display device in first configuration)

4. Example 3 (modification of projection-type display device of Example 2, projection-type display device in second configuration)

5. Example 4 (another modification of projection-type display device of Example 2, projection-type display device in third configuration)

6. Example 5 (modification of projection-type display device of Example 4)

7. Others

### General Description of Optical Element According to First and Second Aspects of the Present Disclosure and Projection-Type Display Device of the Present Disclosure as a Whole

Unless otherwise specified, in optical elements according to first and second aspects of the present disclosure or in an optical element included in a projection-type display device of the present disclosure, a polarization beam splitter, a first polarization beam splitter, a second polarization beam splitter, and a third polarization beam splitter each have a polarization splitting plane, and in light, first light, second light, or third light, P-polarized light passes through the polarization splitting plane while S-polarized light is reflected by the polarization splitting plane.

In one possible configuration, a projection-type display device of the present disclosure further includes:

a second reflective spatial light modulator,

from a light source, second light having a second wavelength range enters a first polarization beam splitter from the same direction as the direction of first light, and

the second light having entered the first polarization beam splitter exits the first polarization beam splitter in a direction different from the direction of the first light, is reflected by the second reflective spatial light modulator, re-enters the first polarization beam splitter, re-exits the first polarization beam splitter in the same direction as the direction of the first light, and travels toward a retardation plate. Note here that the projection-type display device in such a configuration may be referred to as a “projection-type display device in the first configuration” for convenience.

In the projection-type display device in the first configuration, in order that the first light and the second light entering the first polarization beam splitter are in different polarization states, it is preferable to dispose, in front of a position where the first light and the second light enter the first polarization beam splitter, a wavelength-selective retardation plate that changes polarization states of the first light and the second light. The wavelength-selective retardation plate here refers to a retardation plate that makes the polarization state of the first light a first polarization state (for example, the S-polarized state or the P-polarized state) when the first light passes through the plate, and makes the polarization state of the second light a second polarization state (for example, the P-polarized state or the S-polarized state) when the second light passes through the plate. The same applies to the following. Alternatively, In the projection-type display device in the first configuration, in order that the first light and the second light entering the first polarization beam splitter are in different polarization states, the first light and the second light may be branched by a dichroic mirror or the like in the illumination system, one of the first light and the second light may be changed from the first polarization state to the second polarization state by using a half-wave plate or the like, and the first light and the second light may be combined again by a dichroic mirror or the like.

Alternatively, in another possible configuration, the projection-type display device of the present disclosure further includes:

a second reflective spatial light modulator and a second polarization beam splitter, in which

the first light from the light source enters the second polarization beam splitter, exits the second polarization beam splitter, is reflected by the first reflective spatial light modulator, re-enters the second polarization beam splitter, re-exits the second polarization beam splitter, and enters the first polarization beam splitter, and

from the light source, second light having a second wavelength range enters the second polarization beam splitter from the same direction as the direction of the first light, exits the second polarization beam splitter in a direction different from the direction of the first light, is reflected by the second reflective spatial light modulator, re-enters the second polarization beam splitter, re-exits the second polarization beam splitter in the same direction as the direction of the first light, and enters the first polarization beam splitter. Note here that the projection-type display device in a such configuration may be referred to as a “projection-type display device in the second configuration” for convenience.

As in the first configuration, in the projection-type display device in the second configuration, it is preferable to dispose a first wavelength-selective retardation plate that changes the polarization state between the polarization state of the first light re-exiting the second polarization beam splitter and the polarization state of the first light entering the first polarization beam splitter.

Alternatively, in another possible configuration, the projection-type display device of the present disclosure further includes:

a second reflective spatial light modulator, a second polarization beam splitter, and a third polarization beam splitter, in which

the first light from the light source enters the second polarization beam splitter, exits the second polarization beam splitter, is reflected by the first reflective spatial light modulator, re-enters the second polarization beam splitter, re-exits the second polarization beam splitter, and enters the first polarization beam splitter, and

from the light source, second light having a second wavelength range enters the third polarization beam splitter, exits the third polarization beam splitter, is reflected by the second reflective spatial light modulator, re-enters the third polarization beam splitter and enters the first polarization beam splitter via the first changing means, exits the first polarization beam splitter, passes through the retardation plate, and travels toward the projection optical system. Note here that the projection-type display device in such a configuration may be referred to as a “projection-type display device in the third configuration” for convenience.

In another possible configuration, the projection-type display device in the third configuration further includes:

a third reflective spatial light modulator disposed at a position that is adjacent to the third polarization beam splitter and is different from the position of the second reflective spatial light modulator, in which

third light having a third wavelength range that has been emitted from the light source and has entered the third polarization beam splitter exits the third polarization beam splitter, is reflected by the third reflective spatial light modulator, re-enters the third polarization beam splitter, re-exits the third polarization beam splitter in the same direction as the direction of the second light, enters the first changing means, passes through the first changing means, the first polarization beam splitter, and the retardation plate, and travels toward the projection optical system.

The projection-type display device in the third configuration including the preferred configurations described above may be in a mode in which the return light of the second light returning from the projection optical system passes through the retardation plate, enters the first polarization beam splitter, exits the first polarization beam splitter in a direction opposite to the direction in which the first light from the light source entered the first polarization beam splitter, enters the second polarization beam splitter, and exits the first polarization beam splitter in a direction different from the direction in which the first light from the light source exits the first polarization beam splitter.

Alternatively, the projection-type display device in the third configuration including the preferred configurations described above may be in a mode in which return light of the second light returning from the projection optical system passes through the retardation plate, enters the first polarization beam splitter, exits the first polarization beam splitter in a direction opposite to the direction in which the first light from the light source entered the first polarization beam splitter, collides with the second changing means, is returned to the first polarization beam splitter by the second changing means, and exits the first polarization beam splitter in a direction different from the direction in which return light of the second light entered the first polarization beam splitter.

Alternatively, the projection-type display device in the third configuration including the preferred configurations described above may be in a mode in which the return light of the second light returning from the projection optical system passes through the retardation plate, enters the first polarization beam splitter, exits the first polarization beam splitter in a direction opposite to the direction in which the first light from the light source entered the first polarization beam splitter, collides with second changing means to have the light path of the return light changed by the second changing means, or to have the wavelength range or the polarization state of the return light changed by the second changing means, or to be absorbed.

Moreover, the projection-type display device in the third configuration including the preferred configurations and modes described above may be in a mode in which

the projection-type display device further includes a fourth reflective spatial light modulator,

from the light source, fourth light having a fourth wavelength range enters the second polarization beam splitter from the same direction as the direction of the first light, and the fourth light having entered the second polarization beam splitter exits the second polarization beam splitter in a direction different from the direction of the first light, is reflected by the fourth reflective spatial light modulator, re-enters the first polarization beam splitter, re-exits the second polarization beam splitter in the same direction as the direction of the first light, and travels toward the retardation plate.

Moreover, the projection-type display device of the present disclosure including the preferred configurations and modes described above may be in a mode in which a half-wave plate acting on the first light is disposed between the first polarization beam splitter and the retardation plate.

An optical element according to the first aspect of the present disclosure or an optical element included in the projection-type display device of the present disclosure including the preferred configurations and modes described above (these optical elements may be hereinafter collectively referred to as “the optical element or the like of the present disclosure” may be in a mode in which the changing means that changes the light (first light) path includes a light reflective member that reflects return light out of the system (specifically, out of the optical element system or out of the optical system; the same applies to the following), a diffractive grating member (DOE) that releases return light out of the system, or a holographic optical element (HOE) that releases return light out of the system. Additionally, in such a mode, from the viewpoint of reliably reflecting return light out of the system, it is preferable that:

the changing means includes a light reflective member that reflects return light out of the system;

the light that has passed through the retardation plate travels toward the projection optical system, and the return light from the projection optical system passes through the retardation plate; and

an incident angle of the return light incident on a light reflective surface of the changing means is equal to or greater than a cone angle in the medium having the f-number of the projection optical system.

Here, examples of the light reflective member that reflects return light out of the system may include an inclined dichroic mirror, or more specifically, a member having a dichroic mirror formed on the slope of a wedge-shaped prism. Specifically, a dichroic mirror is only needed to be formed on the slope of a wedge-shaped prism in which a glass material or a resin material is stuck. Examples of the light reflective member may also include a transparent and rectangular parallelepiped member having an inclined dichroic mirror formed inside. In these modes, a light reflective member that reflects return light out of the system is embedded in a medium (material) having a refractive index of greater than 1 such as a glass material, and therefore, the condition that the incident angle of return light incident on a light reflective surface of the changing means is equal to or greater than a cone angle in the medium having the f-number is satisfied even when the incident angle is small, whereby the back focus can be made shorter, the projection optical system can be made smaller in size, and the device as a whole can be smaller in size. In order to make the incident angle of return light incident on a light reflective surface of the changing means much smaller, it is preferable that the medium (material) has a higher refractive index in the wavelength range of the first light or the like. Alternatively, in another possible mode, the dichroic mirror is formed on one surface of a retardation plate (retarder) that is inserted between the third reflective spatial light modulator and the first polarization beam splitter, with the disposed retardation plate being inclined, whereby the number of components can be reduced. The dichroic mirror may include a dielectric multi-layer film.

The inclination angle of the diffractive grating member (DOE) or the holographic optical element (HOE) with respect to return light is appropriately determined on the basis of the diffraction angle of the diffractive grating member or the holographic optical element. The diffractive grating member or the holographic optical element may be reflective or transmissive. The diffractive grating member or the holographic optical element may be, for example, stuck or joined to a return light releasing surface of the first polarization beam splitter, or may be formed on one surface of the retardation plate (retarder), or in some cases may be stuck or joined to a cover glass of the second reflective spatial light modulator or of the third reflective spatial light modulator. With these configurations, the number of components can be reduced, the reflective spatial light modulator can be made smaller in size, the projection optical system can be made smaller in size because of a shorter back focus, and the device as a whole can be made smaller in size. Alternatively, for example, the diffractive grating member or the holographic optical element may be mechanically held in the gap between the first polarization beam splitter and the third polarization beam splitter.

Alternatively, the optical element or the like of the present disclosure may be in a mode in which the changing means that converts the wavelength range of return light includes a fluorescent material layer. Specifically, examples of the changing means that converts the wavelength range of return light include a down-conversion or up-conversion fluorescent material layer (a sintered fluorescent material layer, or a glass or resin material layer in which a fluorescent substance is dispersed) and, in the case of such changing means, the fluorescent material layer emits phosphorescence or fluorescence. The fluorescent material layer may be formed on a return light releasing surface of the polarization beam splitter, or may be formed on one surface of the retardation plate (retarder), or in some cases may be formed on a cover glass of the second reflective spatial light modulator or of the third reflective spatial light modulator. With these configurations, the number of components can be reduced, the reflective spatial light modulator can be made smaller in size, and the projection optical system can be made smaller in size because of a shorter back focus. Alternatively, for example, the fluorescent material layer may be held in the gap between the first polarization beam splitter and the third polarization beam splitter.

Alternatively, the optical element or the like of the present disclosure may be in a mode in which

the changing means that changes the polarization state of return light includes a quarter-wave plate and a light reflective member disposed in the order mentioned from the incident side of the return light, and

the light reflective member returns the return light that has passed through the quarter-wave plate to the polarization beam splitter (or the first polarization beam splitter) via the quarter-wave plate. Note that the polarization beam splitter and the first polarization beam splitter may be collectively referred to as the “first polarization beam splitter or the like”. Then, in this case, in one possible mode, the return light returned by the changing means to the first polarization beam splitter or the like exits the first polarization beam splitter or like in a direction that is the direction in which the light from the light source enters the first polarization beam splitter or the like and that is different from the direction in which the return light that has passed through the retardation plate enters the first polarization beam splitter or like.

Configurations and structures of the first changing means, the second changing means, or third changing means, which is described later, may be similar to the configurations and structures of the above-described changing means. The first changing means and the second changing means may have the same configuration and structure, or may have different configurations and structures.

The optical element or the like of the present disclosure including the preferred modes described above may be in a mode in which the retardation plate includes a quarter-wave plate.

Furthermore, with regard to the optical element or the like of the present disclosure including the preferred configurations and modes described above, examples of the light source may include a high-pressure mercury lamp, a xenon lamp, an LED, a superluminescent diode, a semiconductor laser element, a solid-state laser, and a fluorescent light source, and examples of the illumination system that the light emitted from the light source first enters include a fly's eye illumination system or a rod illumination system. Polarization states of the light emitted from the light source are described later.

The projection-type display device of the present disclosure including the preferred configurations and modes described above may be in a mode further including a depolarizing member through which the light that has passed through the projection optical system passes. Furthermore, examples of the first reflective spatial light modulator, the second reflective spatial light modulator, the third reflective spatial light modulator, and the fourth reflective spatial light modulator may include a reflective liquid crystal panel (LCOS) and the like. A retarder may be inserted between any of these panels and the polarization beam splitter to compensate for a skew ray of the polarization beam splitter and a pretilt of the liquid crystal.

The optical element according to the second aspect of the present disclosure may be in a mode in which the heat absorbing member includes a color glass colored with a metal oxide, a color filter in which a dye or pigment is dispersed, a plasmonic color filter in which a fine structure is provided on a metal material, or a dielectric color filter in which a fine structure is provided on a dielectric material. In a case where a color glass or a color filter is included, it is preferable to place the color glass or color filter to be perpendicular to the optical path because astigmatism may occur depending on the thickness or the difference in refractive index from the polarization beam splitter. In a case where a plasmonic color filter or a dielectric color filter is included, the influence of astigmatism can be ignored because such a filter is very thin, and placing such a filter to be inclined with respect to the optical path can prevent a decrease in the ANSI contrast caused by interface reflection on the heat absorbing member itself, that is, caused by the optical element.

### Example 1

Example 1 relates to an optical element according to a first aspect of the present disclosure.

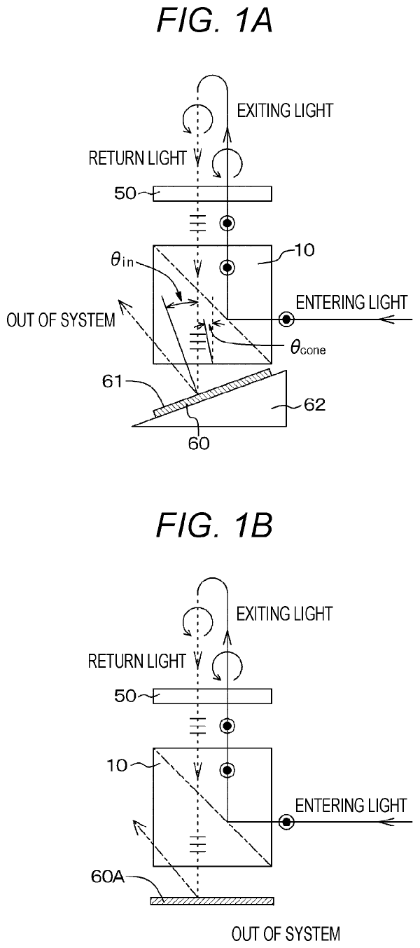

The optical element of Example 1 as illustrated in the conceptual diagram in FIG. 1A includes a polarization beam splitter 10, a retardation plate 50, and changing means 60, in which

the light that has entered the polarization beam splitter 10 from a light source (not illustrated) exits the polarization beam splitter 10 and passes through the retardation plate 50. Then, return light, which is the light that has passed through the retardation plate 50 and has returned to the retardation plate 50, passes through the retardation plate 50, enters the polarization beam splitter 10, exits the polarization beam splitter 10, collides with the changing means 60 to have the light path of the return light changed by the changing means 60. Alternatively, as described later, the wavelength range of the return light is changed, or the polarization state thereof is changed. Alternatively, the return light that has passed through the retardation plate 50 and has returned to the retardation plate 50 passes through the retardation plate 50, enters the polarization beam splitter 10, exits the polarization beam splitter 10, and is absorbed by a heat absorbing member.

Note that, unless otherwise specified, the following description assumes that various polarization beam splitters each have a polarization splitting plane, and, in the light (or first light, second light, and third light), P-polarized light passes through the polarization splitting plane while S-polarized light is reflected by the polarization splitting plane. In addition, the drawings show that the changing means, the retardation plate, the wavelength-selective retardation plate, and the like are disposed to be separate from, for example, the first polarization beam splitter or the like; however, in practice, as described later, these components are integrated in a structure where a surface perpendicular to the optical path is prevented from coming into contact with a medium having a different refractive index to the extent possible.

That is, the S-polarized light (indicated by a solid line) entering the polarization beam splitter 10 from the light source (not illustrated) is reflected by the polarization splitting plane (indicated by a dashed-dotted line), exits the polarization beam splitter 10 in the S-polarized state, and passes through the retardation plate 50 to reach a circularly polarized state. Then, return light in a circularly polarized state (indicated by a broken line), the return light being the light that has passed through the retardation plate 50 and has returned to the retardation plate 50, passes through the retardation plate 50 to go into the P-polarized state, enters the polarization beam splitter 10, exits the polarization beam splitter 10 in a direction different from the direction in which the light from the light source entered the polarization beam splitter 10, that is, passes through the polarization splitting plane of the polarization beam splitter 10, collides with the changing means 60 to have the light path of the return light changed by the changing means 60, and is discarded out of the system (specifically, out of the optical element system or out of the optical system; the same applies to the following). Alternatively, the return light has its wavelength range changed or its polarization state changed, and is discarded out of the system.

The retardation plate 50 includes a quarter-wave plate. In addition, in Example 1, the changing means 60 that changes the light path includes a light reflective member that reflects return light out of the system. Specifically, examples of the light reflective member may include an inclined dichroic mirror, that is, a member having a dichroic mirror formed on the slope of a wedge-shaped prism 62 or may include a transparent and rectangular parallelepiped (or plate-like) member having an inclined dichroic mirror formed inside. Disposing such changing means 60 makes it possible to prevent return light from reaching the observer via the projection optical system and eliminates the possibility that the return light is recognized as an image by the observer, thereby preventing the occurrence of reduced image quality, reduced ANSI contrast of an image, and the like. Then, in this case, from the viewpoint of ensuring that no return light is returned to the projection optical system, it is preferable that the light that has passed through the retardation plate 50 travels toward the projection optical system (not illustrated), return light from the projection optical system passes through the retardation plate 50, the incident angle θᵢₙ of the return light incident on a light reflective surface 61 of the changing means 60 is equal to or greater than a cone angle θ_{cone} in the medium having the f-number of the projection optical system. Here, the medium refers to the medium on which the light reflective surface 61 is placed. The cone angle θ_{cone} is synonymous with an angle formed between a normal line to the reflective spatial light modulator and the maximum light beams in the medium that can be taken by the projection optical system, or with a visual angle in the medium having the numerical aperture (NA) of the projection optical system.

Alternatively, as illustrated in the conceptual diagram of Modification 1 of Example 1 in FIG. 1B, in one possible mode, the changing means 60A includes a diffractive grating member that releases the return light out of the system, or includes a holographic optical element that releases the return light out of the system.

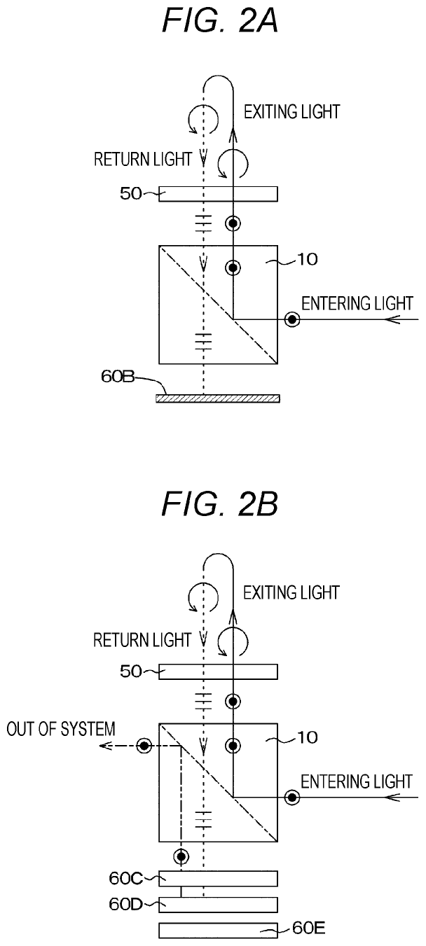

Alternatively, as illustrated in the conceptual diagram of Modification 2 of Example 1 in FIG. 2A, in one possible mode, the changing means 60B that converts the wavelength range of return light includes a fluorescent material layer. Specifically, examples of the changing means 60B that converts the wavelength range of return light include a down-conversion or up-conversion fluorescent material layer (a sintered fluorescent material layer, or a glass or resin material layer in which a fluorescent substance is dispersed) and, in the case of such changing means, the fluorescent material layer absorbs the return light and emits phosphorescence or fluorescence. For example, in a case where the light is green light, up-conversion produces blue light or light having a wavelength shorter than blue light, while down-conversion produces red light or light having a longer wavelength than red light. Therefore, although the phosphorescence or fluorescence, which is out of the visible light region, may reach the observer via the projection optical system, the observer does not recognize any image caused by phosphorescence or fluorescence being out of the visible light region, thereby preventing the occurrence of reduced image quality, reduced ANSI contrast of an image, and the like. Furthermore, since part of the energy absorbed by the fluorescent material layer can be converted into light energy, which in turn can be discharged out of the device through the projection optical system, from the viewpoint of heat generation and heat exhaust, it is preferable to use the changing means 60B that includes a fluorescent material layer. In addition, in a case where the emitted phosphorescence or fluorescence falls in the visible light region, it is only necessary to select an appropriate fluorescent material layer having a wavelength range that does not overlap any of first light, second light, and third light, so that a color filter such as a notch filter (not illustrated) disposed between the changing means 60 and the projection surface absorbs or reflects the phosphorescence or fluorescence.

Alternatively, as illustrated in the conceptual diagram of Modification 3 of Example 1 in FIG. 2B,

the changing means that changes the polarization state of return light includes a quarter-wave plate 60C and a light reflective member 60D, which are disposed in the order mentioned from the incident side of return light, and

the light reflective member 60D returns the return light that has passed through the quarter-wave plate 60C to the polarization beam splitter 10 via the quarter-wave plate 60C. Then, in this case, the return light returned by the changing means 60C and 60D to the polarization beam splitter 10 exits the polarization beam splitter 10 in a direction that is the direction in which the light from the light source enters the polarization beam splitter 10 and is different from the direction in which the return light that has passed through the retardation plate 50 enters the polarization beam splitter 10. Specifically, the return light in the P-polarized state exits the polarization beam splitter 10, passes through the quarter-wave plate 60C, is reflected by the light reflective member 60D, and passes through the quarter-wave plate 60C again, whereby the return light goes into the S-polarized state. Then, the return light in the S-polarized state entering the polarization beam splitter 10 is reflected by the polarization splitting plane, exits the polarization beam splitter 10 in the S-polarized state, and is discarded out of the system.

Note that, if another quarter-wave plate 60E is further disposed between the changing means in which the quarter-wave plate 60C and the light reflective member 60D are included and a third polarization beam splitter 30, which is described later, the quarter-wave plate 60C and the quarter-wave plate 60E act as a retardation plate, or more specifically as a half-wave plate, on the second light and the third light exiting the third polarization beam splitter 30.

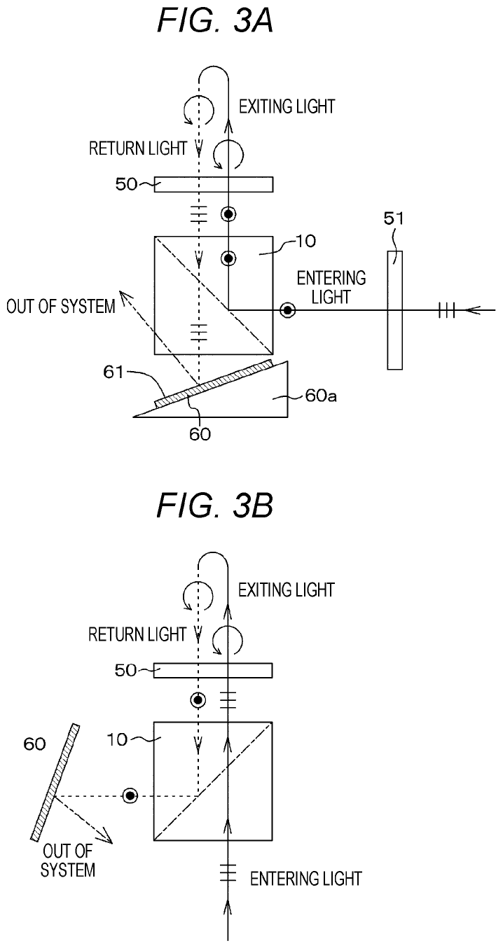

The polarization state of the light incident on the polarization beam splitter 10 from the light source is not limited to the S-polarized state. In a case where the polarization state of the light to enter the polarization beam splitter 10 from the light source is in the P-polarized state, as illustrated in the conceptual diagram of Modification 4 of Example 1 in FIG. 3A, the light that is going to enter the polarization beam splitter 10 may be caused to pass through, for example, a half-wave plate 51 so as to go into the S-polarized state. Alternatively, as illustrated in the conceptual diagram in FIG. 3B of Modification 5 of Example 1, the polarization state can be changed by changing the positions where the retardation plate 50 and the changing means 60 are disposed. That is, the P-polarized light incident on the polarization beam splitter 10 from the light source passes through the polarization splitting plane, exits the polarization beam splitter 10 in P-polarized state, passes through the retardation plate 50, and reaches a circularly polarized state. Then, return light in a circularly polarized state, the return light being the light that has passed through the retardation plate 50 and has returned to the retardation plate 50, passes through the retardation plate 50 to go into the S-polarized state, enters the polarization beam splitter 10, is reflected by the polarization splitting plane, exits the polarization beam splitter 10 in a direction different from the direction in which the light from the light source entered the polarization beam splitter 10, collides with the changing means 60 to have the light path, the wavelength range, or the polarization state of the return light changed by the changing means 60, and is discarded out of the system.

The heat absorbing member includes a color glass colored with a metal oxide, a color filter in which a dye or pigment is dispersed, a plasmonic color filter in which a fine structure is provided on a metal material, or a dielectric color filter in which a fine structure is provided on a dielectric material, and specific examples of the heat absorbing member may include a sharp cut filter, a blue absorbing filter, a green absorbing filter, a wavelength correction filter, a hole array, disk array, or pillar array of an aluminum (Al) thin film, or a hole array, disk array, or pillar array of an Si thin film. In addition, the heat absorbing member is preferably disposed to be inclined with respect to the optical path, whereby the light reflected by the heat absorbing member is inhibited from entering the polarization beam splitter 10.

### Example 2

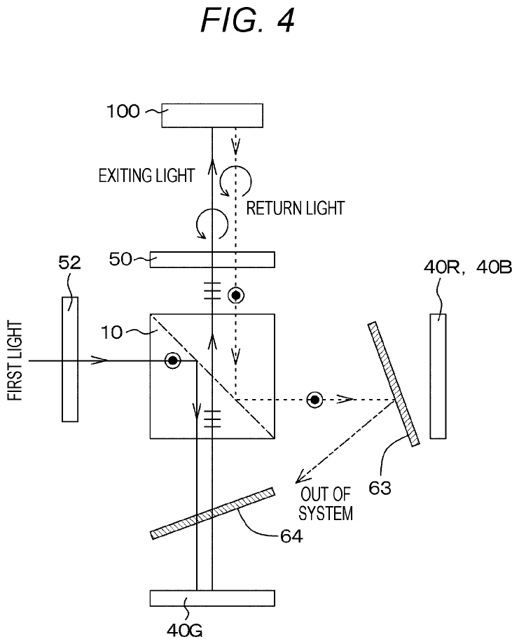

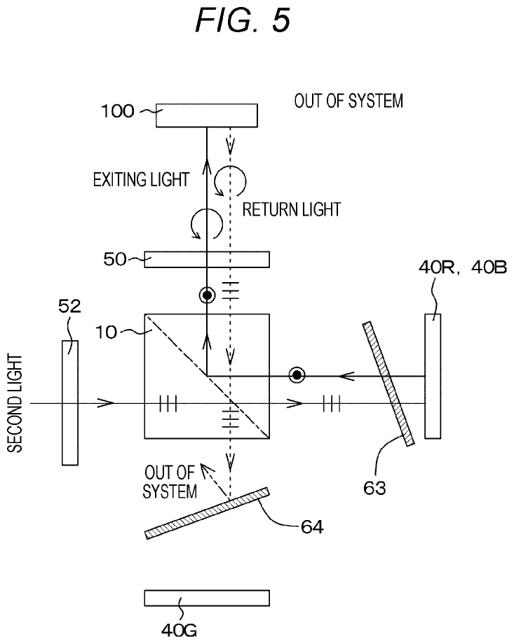

Example 2, which is a modification of Example 1, relates to a projection-type display device of the present disclosure, and more particularly, to a projection-type display device in a first configuration. FIGS. 4 and 5 show conceptual diagrams of the projection-type display device of Example 1.

As illustrated in FIG. 4, the projection-type display device of Example 2 includes:

an optical element including a first polarization beam splitter 10, a retardation plate 50, and first changing means 63; and

a first reflective spatial light modulator 40G, in which

first light (specifically, green light), which has a first wavelength range, is emitted from a light source (not illustrated), enters the first polarization beam splitter 10 via the first reflective spatial light modulator 40G, exits the first polarization beam splitter 10, passes through the retardation plate 50, and travels toward the projection optical system 100, and

return light of the first light returning from the projection optical system 100 passes through the retardation plate 50, enters the first polarization beam splitter 10, exits the first polarization beam splitter 10, and collides with the first changing means 63 to have the light path, the wavelength range, or the polarization state of the return light changed by the first changing means 63.

The first changing means 63 has a configuration and structure having no effect on second light (and third light, which is described later). That is, the first changing means 63 does not reflect but transmits the second light (and the third light, which is described later) and reflects the first light. Alternatively, the first changing means 63 may have a configuration and structure intended not to reflect but to transmit the second light (and the third light, which is described later) falling within part of its wavelength range, and to reflect the second light (and the third light, which is described later) falling within the remaining part of its wavelength range as well as reflecting the first light. In this case, the first changing means 63 acts as a type of trimming filter for obtaining a desired color with respect to the second light (and the third light, which is described later). In addition, the second changing means 64 has a configuration and structure having no effect on the first light. That is, the second changing means 64 does not reflect but transmits the first light and reflects the second light (and the third light, which is described later). Alternatively, the second changing means 64 may have a configuration and structure intended not to reflect but to transmit the first light falling within part of its wavelength range, and to reflect the first light falling within the remaining part of its wavelength range as well as reflecting the second light (and the third light, which is described later). In these cases, the second changing means 64 acts as a type of trimming filter for obtaining a desired color with respect to the first light. Then, as a result, the color gamut can be extended and controlled. The light path, the wavelength range, or the polarization state of light is also changed by the second changing means 64. The first changing means 63 and the second changing means 64 may have substantially the same configuration and structure except that wavelength ranges of light affected by the changing means are different, or may have different configurations and different structures. The description above also applies to the following examples.

In the projection-type display device of Example 2, specifically, the first light in the S-polarized state coming from the light source enters the first polarization beam splitter 10, is reflected by the polarization splitting plane, exits the first polarization beam splitter 10 in the S-polarization state, passes through the second changing means 64, and enters the first reflective spatial light modulator 40G. The first light is modulated in accordance with an image signal such that a bright part of the image is modulated into the P-polarized state, exits the first reflective spatial light modulator 40G, passes through the second changing means 64, and reaches the first polarization beam splitter 10. Then, the first light in the P-polarized state incident on the first polarization beam splitter 10 passes through the polarization splitting plane, exits the first polarization beam splitter 10, and passes through the retardation plate 50, which includes a quarter-wave plate, to reach a circularly polarized state. Then, the light is projected from the projection optical system 100 onto the projection surface. At the same time, part of the light returns to the retardation plate 50, as return light caused by interface reflection on a lens or the like inside the projection optical system 100. The return light of the first light that has returned to the retardation plate 50 in a circularly polarized state passes through the retardation plate 50 to go into the S-polarized state, enters the first polarization beam splitter 10, exits the first polarization beam splitter 10, that is, the return light is reflected by the polarization splitting plane in the first polarization beam splitter 10, collides with the first changing means 63 to have the light path, the wavelength range, or the polarization state of the return light changed by the first changing means 63, and is discarded out of the system. In this way, the occurrence of ghost light on the projection surface can be suppressed. Since ghost light is reduced, the light incident on a dark part of the projected image is reduced, thereby improving the ANSI contrast.

Furthermore, as illustrated in the conceptual diagram in FIG. 5, the projection-type display device of Example 2 further includes:

a second reflective spatial light modulator 40R, 40B, in which

from the light source, second light having a second wavelength range (specifically, red light and blue light) enters the first polarization beam splitter 10 from the same direction as the first light, and

the second light having entered the first polarization beam splitter 10 exits the first polarization beam splitter 10 in a direction different from the direction of the first light, is reflected by the second reflective spatial light modulator 40R, 40B, re-enters the first polarization beam splitter 10, re-exits the first polarization beam splitter 10 in the same direction as the direction of the first light, and travels toward the retardation plate 50.

Specifically, the second light having entered the first polarization beam splitter 10 in the P-polarized state from the light source passes through the polarization splitting plane, exits the first polarization beam splitter 10 in the P-polarized state, passes through the first changing means 63, enters the second reflective spatial light modulator 40R, 40B, exits the second reflective spatial light modulator 40R, 40B, passes through the first changing means 63, and reaches the first polarization beam splitter 10. In this state, the polarization state of the second light is the S-polarized state. Then, the second light in the S-polarized state incident on the first polarization beam splitter 10 is reflected by the polarization splitting plane, exits the first polarization beam splitter 10, and passes through the retardation plate 50 to reach a circularly polarized state. Then, the light is projected from the projection optical system 100 onto the projection surface. At the same time, part of the light returns to the retardation plate 50, as return light caused by interface reflection on a lens or the like inside the projection optical system 100. The return light in a circularly polarized state, the return light being the light that has passed through the retardation plate 50 and has returned to the retardation plate 50, passes through the retardation plate 50 to go into the P-polarized state, enters the polarization beam splitter 10, exits the first polarization beam splitter 10 in a direction different from the direction in which the second light from the light source entered the first polarization beam splitter 10, that is, the return light passes through the polarization splitting plane in the first polarization beam splitter 10, collides with the second changing means 64 to have the light path, the wavelength range, or the polarization state of the return light changed by the second changing means 64, and is discarded out of the system, thereby improving the ANSI contrast.

In order that the first light in the S-polarized state enters the first polarization beam splitter 10 and the second light in the P-polarized state enters the first polarization beam splitter 10, it is only necessary to dispose, in a space where the first light and the second light are to enter the first polarization beam splitter 10, that is, in front of a position where the first light and the second light enter the first polarization beam splitter 10, a wavelength-selective retardation plate 52 that changes the polarization states of the first light and the second light (for example, ColorSelect (registered trademark) provided by ColorLink Japan, Ltd.), that is, the wavelength-selective retardation plate 52 intended to make the first light in the S-polarized state enter the first polarization beam splitter 10 and the second light in the P-polarized state enter the first polarization beam splitter 10. In this case, the projection-type display device may have a configuration in which white light including the first light and the second light enters the wavelength-selective retardation plate 52 from the light source. Alternatively, the light from the light source may be time-divided to generate the first light of green, the second light of red, and the second light of blue, each of which is caused to enter the first polarization beam splitter 10. Alternatively, in order that the first light and the second light entering the first polarization beam splitter 10 are in different polarization states, the first light and the second light may be branched by a dichroic mirror or the like (not illustrated) in the illumination system, one of the first light and the second light may be changed from the first polarization state to the second polarization state by using a half-wave plate or the like (not illustrated), and the first light and the second light may be combined again by a dichroic mirror or the like (not illustrated).

### Example 3

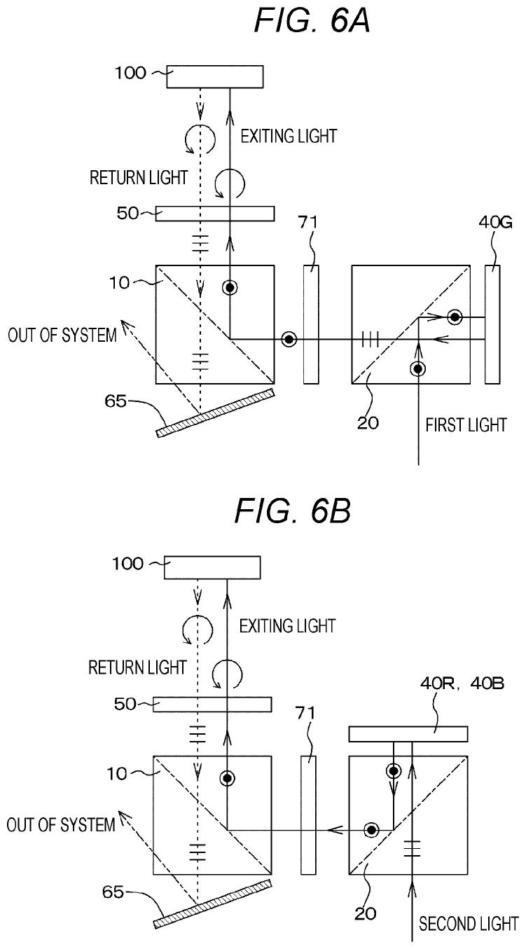

Example 3 is a modification of the projection-type display device of Example 2, and more specifically, Example 3 is the projection-type display device in a second configuration. FIGS. 6A and 6B show conceptual diagrams of the projection-type display device of Example 3. The projection-type display device of Example 3 further includes:

a second reflective spatial light modulator 40R, 40B and a second polarization beam splitter 20, in which

the first light from the light source enters the second polarization beam splitter 20, exits the second polarization beam splitter 20, is reflected by the first reflective spatial light modulator 40G, re-enters the second polarization beam splitter 20, re-exits the second polarization beam splitter 20, and enters the first polarization beam splitter 10. In addition, from the light source, the second light having a second wavelength range enters the second polarization beam splitter 20 from the same direction as the first light, exits the second polarization beam splitter 20 in a direction different from the direction of the first light, is reflected by the second reflective spatial light modulator 40R, 40B, re-enters the second polarization beam splitter 20, re-exits the second polarization beam splitter 20 in the same direction as the direction of the first light, and enters the first polarization beam splitter 10.

Note here that a first wavelength-selective retardation plate 71 that changes the polarization state between the first light that has re-exited the second polarization beam splitter 20 and the first light that is entering the first polarization beam splitter 10 is disposed between the second polarization beam splitter 20 and the first polarization beam splitter 10.

The first wavelength-selective retardation plate 71 changes the polarization state of the first light from the P-polarized state to the S-polarized state. That is, the first light in the P-polarized state passes through the first wavelength-selective retardation plate 71 to go into the S-polarized state. On the other hand, the second light or the third light in the S-polarized state remains in the S-polarized state after passing through the first wavelength-selective retardation plate 71.

Specifically, as illustrated in FIG. 6A, the first light having entered the second polarization beam splitter 20 from the light source in the S-polarized state is reflected by the polarization splitting plane, exits the second polarization beam splitter 20 in the S-polarized state, enters the first reflective spatial light modulator 40G, exits the first reflective spatial light modulator 40G, enters the second polarization beam splitter 20 in the P-polarized state, passes through the polarization splitting plane, and exits the second polarization beam splitter 20. Then, the light passes through the first wavelength-selective retardation plate 71 to go into the S-polarized state, and reaches the first polarization beam splitter 10. In this state, the polarization state of the first light is the S-polarized state, and thus the first light is reflected by the polarization splitting plane, exits the first polarization beam splitter 10, passes through the retardation plate 50 to reach a circularly polarized state. Then, the light is projected from the projection optical system 100 onto the projection surface. At the same time, part of the light returns to the retardation plate 50, as return light caused by interface reflection on a lens or the like inside the projection optical system 100. The return light of the first light in a circularly polarized state, the return light being the light that has passed through the retardation plate 50 and has returned to the retardation plate 50, passes through the retardation plate 50 to go into the P-polarized state, enters the first polarization beam splitter 10, passes through the polarization splitting plane, exits the first polarization beam splitter 10 in a direction different from the direction in which the first light entered the first polarization beam splitter 10, collides with the first changing means 65 to have the light path, the wavelength range, or the polarization state of the return light changed by the first changing means 65, and is discarded out of the system. Then, the return light of the first light no longer re-enters the projection optical system 100, thereby preventing a decrease in the ANSI contrast.

Furthermore, as illustrated in FIG. 6B, the second light having entered the second polarization beam splitter 20 from the light source in the P-polarized state passes through the polarization splitting plane, exits the second polarization beam splitter 20 in the P-polarized state, enters the second reflective spatial light modulator 40R, 40B, exits the second reflective spatial light modulator 40R, 40B, enters the second polarization beam splitter 20 in the S-polarized state, is reflected by the polarization splitting plane, and exits the second polarization beam splitter 20. Then, the light is still in the S-polarized state after passing through the first wavelength-selective retardation plate 71 and reaches the first polarization beam splitter 10. In this state, the polarization state of the second light is the S-polarized state, and thus the second light is reflected by the polarization splitting plane, exits the first polarization beam splitter 10, passes through the retardation plate 50 to reach a circularly polarized state. Then, the light is projected from the projection optical system 100 onto the projection surface. At the same time, part of the light returns to the retardation plate 50, as return light caused by interface reflection on a lens or the like inside the projection optical system 100. The return light of the second light in a circularly polarized state, the return light being the light that has passed through the retardation plate 50 and has returned to the retardation plate 50, passes through the retardation plate 50 to go into the P-polarized state, enters the first polarization beam splitter 10, passes through the polarization splitting plane, exits the first polarization beam splitter 10 in a direction different from the direction in which the second light entered the first polarization beam splitter 10, collides with the first changing means 65 to have the light path, the wavelength range, or the polarization state of the return light changed by the first changing means 65, and is discarded out of the system. That is, owing to the first changing means 65, both the first light and the second light have their light paths, their wavelength ranges, or their polarization states changed by the first changing means 65, and are discarded out of the system. Then, the return light of the second light no longer re-enters the projection optical system 100, thereby preventing a decrease in the ANSI contrast.

Note that functions of the first changing means 63 and the second changing means 64 are different from functions of the first changing means 65 between the projection-type display device of Example 2 as illustrated in FIGS. 4 and 5 and the projection-type display device of Example 3 as illustrated in FIGS. 6A and 6B. The first wavelength-selective retardation plate 71 changes the first light from the P-polarized state to the S-polarized state, while keeping the S-polarized state of the second light unchanged. In addition, in order that the first light in the S-polarized state enters the second polarization beam splitter 20 and the second light in the P-polarized state enters the second polarization beam splitter 20, it is only necessary to dispose, in a space where the first light and the second light are to enter the second polarization beam splitter 20, that is, in front of a position where the first light and the second light enter the second polarization beam splitter 20, a wavelength-selective retardation plate that changes the polarization states of the first light and the second light, that is, a wavelength-selective retardation plate intended to make the first light in the S-polarized state enter the second polarization beam splitter 20 and the second light in the P-polarized state enter the second polarization beam splitter 20. Alternatively, the light from the light source may be time-divided to generate the first light of green, the second light of red, and the second light of blue, each of which is caused to enter the second polarization beam splitter 20. Alternatively, in order that the first light and the second in different polarization states enter the second polarization beam splitter 20, the first light and the second light may be branched by a dichroic mirror or the like (not illustrated) in the illumination system, one of the first light and the second light may be changed from the first polarization state to the second polarization state by using a half-wave plate or the like (not illustrated), and the first light and the second light may be combined again by a dichroic mirror or the like (not illustrated).

### Example 4

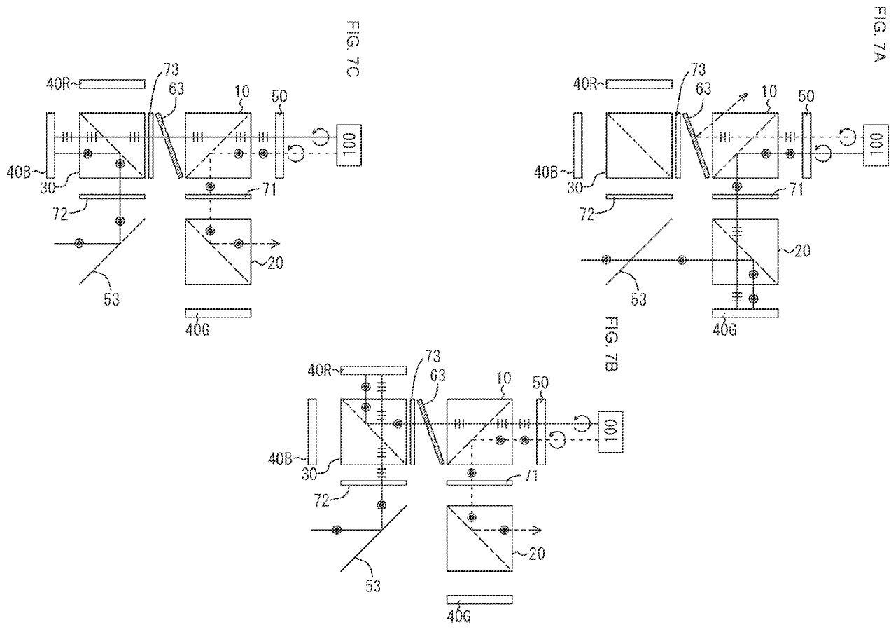

Example 4, which is also a modification of the projection-type display device of Example 2, relates to a projection-type display device in a third configuration. FIG. 7 shows conceptual diagrams of the projection-type display device of Example 4; (A) of FIG. 7 illustrates a behavior of first light (specifically, green light), (B) of FIG. 7 illustrates a behavior of second light (specifically, red light), and (C) of FIG. 7 illustrates a behavior of third light (specifically, blue light).

The projection-type display device of Example 4 further includes:

a second reflective spatial light modulator 40R, a second polarization beam splitter 20, and a third polarization beam splitter 30, in which first light (green light, for example) from the light source enters the second polarization beam splitter 20, exits the second polarization beam splitter 20, is reflected by the first reflective spatial light modulator 40G, re-enters the second polarization beam splitter 20, re-exits the second polarization beam splitter 20, and enters the first polarization beam splitter 10, and

from the light source, second light (red light, for example) having a second wavelength range enters the third polarization beam splitter 30, exits the third polarization beam splitter 30, is reflected by the second reflective spatial light modulator 40R, re-enters the third polarization beam splitter 30, re-exits the third polarization beam splitter 30, enters the first polarization beam splitter 10 via the first changing means 63, exits the first polarization beam splitter 10, passes through the retardation plate 50, and travels toward the projection optical system 100.

Furthermore, the projection-type display device of Example 4 further includes:

a third reflective spatial light modulator 40B disposed at a position that is adjacent to the third polarization beam splitter 30 and is different from the position of the second reflective spatial light modulator 40R, in which

third light having a third wavelength range (blue light, for example) that has been emitted from the light source and has entered the third polarization beam splitter 30 exits the third polarization beam splitter 30, is reflected by the third reflective spatial light modulator 40B, re-enters the third polarization beam splitter 30, re-exits the third polarization beam splitter 30 in the same direction as the direction of the second light, enters the first changing means 63, passes through the first changing means 63, the first polarization beam splitter 10, and the retardation plate 50, and travels toward the projection optical system.

Moreover, return light of the second light and the third light returning from the projection optical system 100 passes through the retardation plate 50, enters the first polarization beam splitter 10, exits the first polarization beam splitter 10 in a direction opposite to the direction in which the first light from the light source entered the first polarization beam splitter 10, enters the second polarization beam splitter 20, exits the first polarization beam splitter 10 in a direction different from the direction in which the first light from the light source exits the first polarization beam splitter 10, and is discarded.

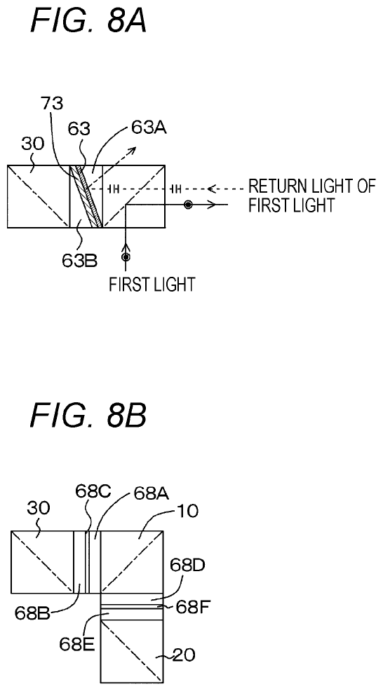

Although (A), (B), and (C) of FIG. 7 show that the first changing means 63 is disposed to be separate from the first polarization beam splitter 10, it is preferable that, as illustrated in FIG. 8A, a wedge-shaped prism 63A having a slope on which a dichroic mirror included in the first changing means 63 is formed is integrated with the first polarization beam splitter 10. Furthermore, it is preferable that a wedge-shaped prism 63B is integrated with the third polarization beam splitter 30. The term “integrated” here means that the polarization beam splitter 10, 30 and the wedge-shaped prism 63A, 63B are stuck together or joined together, or are produced from a single base material. Production from a single base material reduces the vertical interface, thereby preventing a decrease in the ANSI contrast caused by an optical element. Furthermore, since the two wedge-shaped prisms 63A and 63B are integrated with the polarization beam splitters 10 and 30, respectively, a third wavelength-selective retardation plate 73, which is described later, is to be disposed on a slope of the wedge-shaped prism 63B, which also provides an effect of preventing a decrease in the ANSI contrast caused by an optical element for the same reason. However, since there is a trade-off relationship between astigmatism and the thickness and inclination of the third wavelength-selective retardation plate 73, the inclination being represented by the vertex angle of the wedge-shaped prism 63A, the astigmatism may not be acceptable depending on the thickness or the inclination of the third wavelength-selective retardation plate 73. In this case, it is preferable that the wedge-shaped prism 63A is integrated with the first polarization beam splitter 10 and the third wavelength-selective retardation plate 73 is disposed on a vertical interface between the third polarization beam splitter 30 and the wedge-shaped prism 63B.

Specifically, as illustrated in (A) of FIG. 7 showing a behavior of first light (specifically, green light), from the light source (not illustrated), the first light in the S-polarized state passes through a dichroic mirror 53 disposed in the illumination system, enters the second polarization beam splitter 20, is reflected by the polarization splitting plane, exits the second polarization beam splitter 20 in the S-polarized state, enters the first reflective spatial light modulator 40G, exits the first reflective spatial light modulator 40G, enters the second polarization beam splitter 20 in the P-polarized state, passes through the polarization splitting plane, and exits the second polarization beam splitter 20. Then, the light passes through the first wavelength-selective retardation plate 71 to go into the S-polarized state, and reaches the first polarization beam splitter 10. In this state, the polarization state of the first light is the S-polarized state, and thus the first light is reflected by the polarization splitting plane, exits the first polarization beam splitter 10, passes through the retardation plate 50 to reach a circularly polarized state, and travels toward the projection optical system 100. Then, the light is projected from the projection optical system 100 onto the projection surface. At the same time, part of the light returns to the retardation plate 50, as return light caused by interface reflection on a lens or the like inside the projection optical system 100. Having returned from the projection optical system 100 to the retardation plate 50, the return light of the first light in a circularly polarized state passes through the retardation plate 50 to go into the P-polarized state, enters the first polarization beam splitter 10, passes through the polarization splitting plane, exits the first polarization beam splitter 10 in a direction different from the direction in which the first light entered the first polarization beam splitter 10, collides with the first changing means 63 to have the light path, the wavelength range, or the polarization state of the return light changed by the first changing means 63, and is discarded out of the system, thereby improving the ANSI contrast.

Furthermore, as illustrated in (B) of FIG. 7, the second light in the S-polarized state as coming from the light source is reflected by a reflection surface (indicated by a line segment) on the dichroic mirror 53 disposed in the illumination system, passes through the second wavelength-selective retardation plate 72 to go into the P-polarized state, and reaches the third polarization beam splitter 30. In this state, the polarization state of the second light is the P-polarized state, and thus the second light having entered the third polarization beam splitter 30 passes through the polarization splitting plane, is reflected by the second reflective spatial light modulator 40R, and re-enters the third polarization beam splitter 30. At this time, the polarization state of the second light is the S-polarized state. Having entered the third polarization beam splitter 30, the second light is reflected by the polarization splitting plane, and passes through the third wavelength-selective retardation plate 73 to go into the P-polarized state. Then, the light passes through the first changing means 63, further passes through the first polarization beam splitter 10 and the retardation plate 50 to reach a circularly polarized state, and travels toward the projection optical system 100. Then, the light is projected from the projection optical system 100 onto the projection surface. At the same time, part of the light returns to the retardation plate 50, as return light caused by interface reflection on a lens or the like inside the projection optical system 100. The return light in a circularly polarized state of the first light returning from the projection optical system 100 passes through the retardation plate 50 to go into the S-polarized state, enters the first polarization beam splitter 10, is reflected by the polarization splitting plane, exits the first polarization beam splitter 10 in a direction opposite to the direction in which the first light entered the first polarization beam splitter 10, passes through the first wavelength-selective retardation plate 71 with the polarization state of the second light being still the S-polarized state, enters the second polarization beam splitter 20 in the S-polarized state, is reflected by the polarization splitting plane, exits the second polarization beam splitter 20 in a direction different from the direction in which the first light from the light source exits the second polarization beam splitter 20, and is discarded out of the system. That is, by using the first wavelength-selective retardation plate 71 instead of a general wide-range half-wave plate, return light of the second light and the third light, which is described later, can be discarded out of a free surface (hereinafter also referred to as a “free port”) on the second polarization beam splitter 20 to the outside of the system, thereby improving the ANSI contrast.

Furthermore, as illustrated in (C) of FIG. 7, the third light in the S-polarized state as coming from the light source is reflected by a reflection surface (indicated by a line segment) on the dichroic mirror 53 disposed in the illumination system, passes through the second wavelength-selective retardation plate 72 while remaining in the S-polarized state, and reaches the third polarization beam splitter 30. In this state, the polarization state of the third light is the S-polarized state, and thus the third light having entered the third polarization beam splitter 30 is reflected by the polarization splitting plane, is reflected by the third reflective spatial light modulator 40B, and re-enters the third polarization beam splitter 30. At this time, the polarization state of the third light is the P-polarized state. Having entered the third polarization beam splitter 30, the third light passes through the polarization splitting plane, and passes through the third wavelength-selective retardation plate 73 while remaining in the P-polarized state. Then, the light passes through the first changing means 63, further passes through the first polarization beam splitter 10 and the retardation plate 50 to reach a circularly polarized state, and travels toward the projection optical system 100. Then, the light is projected from the projection optical system 100 onto the projection surface. At the same time, part of the light returns to the retardation plate 50, as return light caused by interface reflection on a lens or the like inside the projection optical system 100. The return light in a circularly polarized state of the first light returning from the projection optical system 100 passes through the retardation plate 50 to go into the S-polarized state, enters the first polarization beam splitter 10, is reflected by the polarization splitting plane, exits the first polarization beam splitter 10 in a direction opposite to the direction in which the first light entered the first polarization beam splitter 10, passes through the first wavelength-selective retardation plate 71 with the polarization state of the third light being still the S-polarized state, enters the second polarization beam splitter 20 in the S-polarized state, is reflected by the polarization splitting plane, exits the first polarization beam splitter 10 in a direction different from the direction in which the first light from the light source exits the first polarization beam splitter 10, and is discarded out of the system, thereby improving the ANSI contrast.

The means and method for discarding the second light and the third light out of the system (out of the optical element system or out of the optical system) are not limited to the means and methods described above.

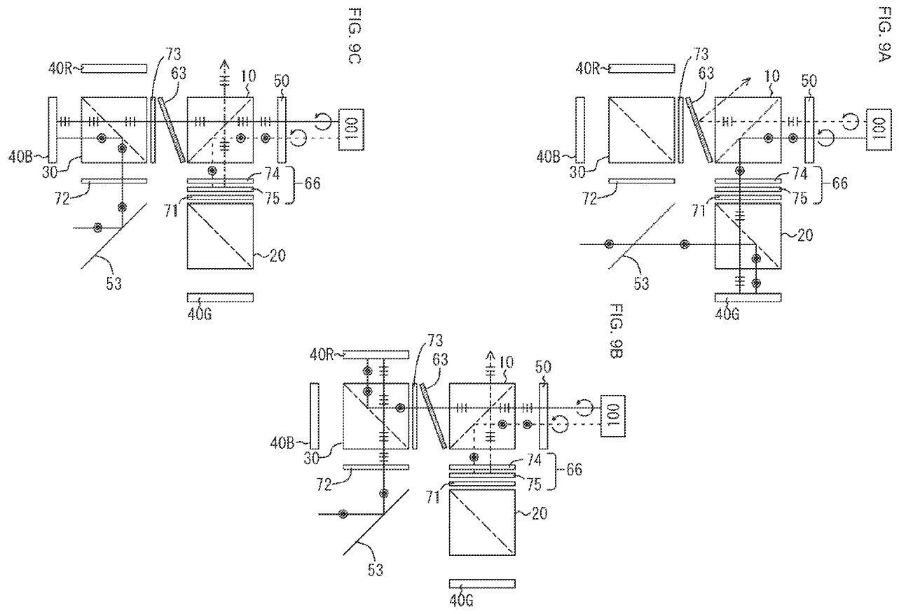

FIG. 9 shows conceptual diagrams of the projection-type display device according to Modification 1 of Example 4; (A) of FIG. 9 illustrates a behavior of first light (specifically, green light), (B) of FIG. 9 illustrates a behavior of second light (specifically, red light), and (C) of FIG. 9 illustrates a behavior of third light (specifically, blue light). The projection-type display device of Modification 1 of Example 4 may be in a mode in which return light of the second light and the third light returning from the projection optical system 100 passes through the retardation plate 50, enters the first polarization beam splitter 10, exits the first polarization beam splitter 10 in a direction opposite to the direction in which the first light from the light source entered the first polarization beam splitter 10, collides with the second changing means 66, is returned to the first polarization beam splitter 10 by the second changing means 66, and exits the first polarization beam splitter 10 in a direction different from the direction in which return light of the second light and third light entered the first polarization beam splitter 10. The second changing means 66 includes a combination of the first wavelength-selective retardation plate 71, a light reflective member 75, and a fourth wavelength-selective retardation plate 74.

The combination of the first wavelength-selective retardation plate 71, the light reflective member 75, and the fourth wavelength-selective retardation plate 74 has functions, with regard to the second light and the third light, similar to the functions of the quarter-wave plate 60E, the light reflective member 60D, and the quarter-wave plate 60C according to Modification 3 of Example 1 as illustrated in FIG. 2B. That is, with respect to the second light and the third light, the light reflective member 75 returns the return light that has passed through the fourth wavelength-selective retardation plate 74 to the polarization beam splitter 10 via the fourth wavelength-selective retardation plate 74. Then, in this case, the return light of the second light and third light that has been returned to the polarization beam splitter 10 by the light reflective member 75 and the fourth wavelength-selective retardation plate 74 passes through the polarization beam splitter 10 and exits the polarization beam splitter 10. Specifically, the return light in the S-polarized state exiting the polarization beam splitter 10 passes through the fourth wavelength-selective retardation plate 74, is reflected by the light reflective member 75, and passes through the fourth wavelength-selective retardation plate 74 again to go into the P-polarized state. Then, the return light in the P-polarized state entering the polarization beam splitter 10 passes through the polarization splitting plane, exits the polarization beam splitter 10 in the P-polarized state, and is discarded out of the system.

The fourth wavelength-selective retardation plate 74 is only needed to act as a quarter-wave plate on the first light, the second light, and the third light, and thus wavelength selectivity may be unnecessary in some cases. The first wavelength-selective retardation plate 71 is only needed to act as a quarter-wave plate at least on the first light, and thus wavelength selectivity may be unnecessary in some cases. Table 1 below shows the polarization state as of the time when the first light, the second light, or the third light enters the second changing means 66, and the polarization state as of the time when the first light, the second light, or the third light exits the second changing means 66.

TABLE 1

| | First light | Second light | Third light |
|---|---|---|---|
| When entering | P-polarized state | S-polarized state | S-polarized state |
| First wavelength-selective retardation plate 71 | Quarter-wave plate | | |
| Light reflective member 75 | Transmit | | |
| Fourth wavelength-selective retardation plate 74 | Quarter-wave plate | | |
| Fourth wavelength-selective retardation plate 74 | | Quarter-wave plate | Quarter-wave plate |
| Light reflective member 75 | | Reflect | Reflect |
| Fourth wavelength-selective retardation plate 74 | | Quarter-wave plate | Quarter-wave plate |
| When exiting | S-polarized state | P-polarized state | P-polarized state |

Specifically, as illustrated in (A) of FIG. 9 showing the behavior of the first light (specifically, green light), the behavior of the first light is similar to the behavior of the first light (specifically, green light) illustrated in (A) FIG. 7 except that the light passes through the light reflective member 75 and the fourth wavelength-selective retardation plate 74.

Furthermore, as illustrated in (B) of FIG. 9, the second light's behavior exhibited until return light of the second light exits the first polarization beam splitter 10 in a direction opposite to the direction in which the first light entered the first polarization beam splitter 10 is similar to the behavior of the second light as illustrated in (B) of FIG. 7. Then, the second light in the S-polarized state exiting the first polarization beam splitter 10 passes through the fourth wavelength-selective retardation plate 74 to reach a circularly polarized state, is reflected by the light reflective member 75, passes through the fourth wavelength-selective retardation plate 74 again to go into the P-polarized state, enters the first polarization beam splitter 10, passes through the polarization splitting plane, exits the first polarization beam splitter 10, and is discarded out of the system, thereby improving the ANSI contrast.

Moreover, as shown in (C) of FIG. 9, the behavior of return light of the third light is similar to the behavior of the second light illustrated in (B) of FIG. 9.

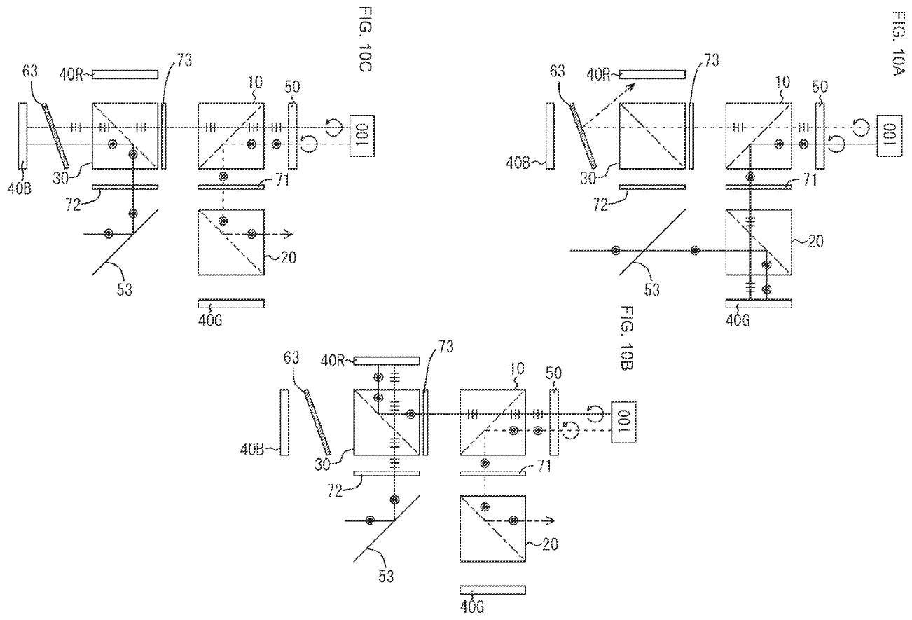

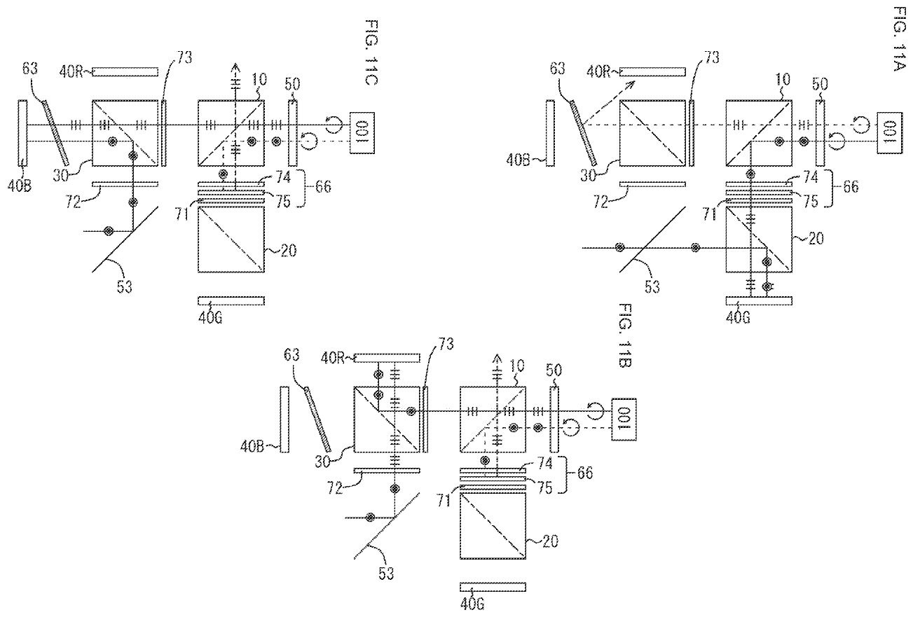

FIGS. 10 and 11 show conceptual diagrams of the projection-type display devices according to Modification 2 and Modification 3, respectively, of Example 4; (A) of FIG. 10 and (A) of FIG. 11 each illustrate a behavior of first light (specifically, green light), (B) of FIG. 10 and (B) of FIG. 11 each illustrate a behavior of second light (specifically, red light), and (C) of FIG. 10 and (C) of FIG. 11 each illustrate a behavior of third light (specifically, blue light). The projection-type display devices shown in FIGS. 10 and 11 according to Modification 2 and Modification 3 of Example 4 differ from the projection-type display devices according to Example 4 and Modification 1 of Example 4 in that the first changing means 63 is disposed at a different position. Specifically, the first changing means 63 is disposed between the third polarization beam splitter 30 and the third reflective spatial light modulator 40B. The projection-type display devices according to Modification 2 and Modification 3 of Example 4 in the other aspects can be similar to the projection-type display device according to Example 4 and the projection-type display device according to Modification 1 of Example 4, and thus detailed description thereof is omitted.

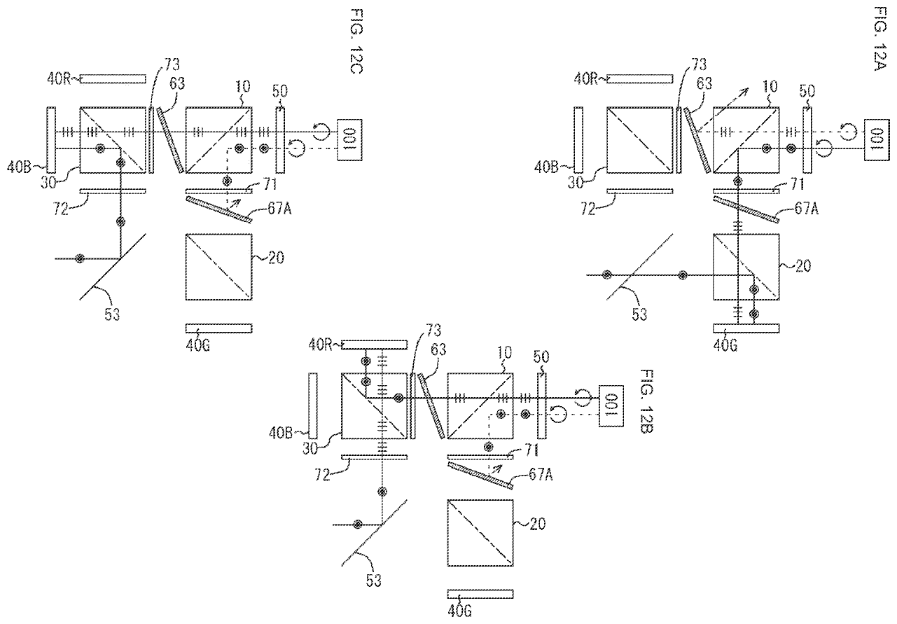

FIG. 12 shows conceptual diagrams of the projection-type display device according to Modification 4 of Example 4; (A) of FIG. 12 illustrates a behavior of first light (specifically, green light), (B) of FIG. 12 illustrates a behavior of second light (specifically, red light), and (C) of FIG. 12 illustrates a behavior of third light (specifically, blue light). In the projection-type display device illustrated in FIG. 12 according to Modification 4 of Example 4, return light of the second light and the third light returning from the projection optical system 100 passes through the retardation plate 50, enters the first polarization beam splitter 10, exits the first polarization beam splitter 10 in a direction opposite to the direction in which the first light from the light source entered the first polarization beam splitter 10, collides with the second changing means 67A to have the light path of the return light changed by the second changing means 67A, or have the wavelength range or the polarization state of the return light changed by the second changing means 67A, or is absorbed, and is discarded out of the system, thereby improving the ANSI contrast. The second changing means 67A has the same functions as the functions of the second changing means 64 in the projection-type display device of Example 2.

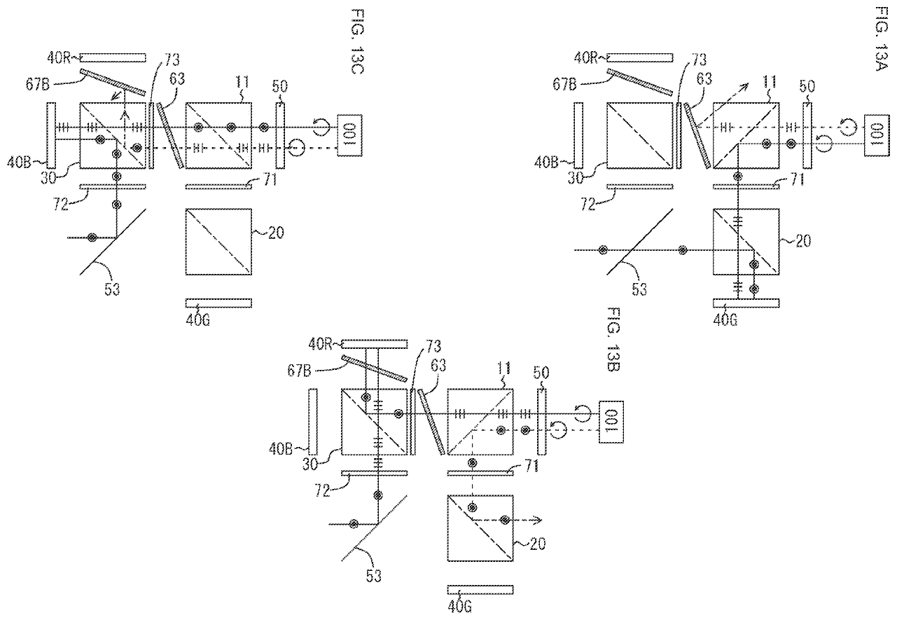

FIG. 13 shows conceptual diagrams of the projection-type display device according to Modification 5 of Example 4; (A) of FIG. 13 illustrates a behavior of first light (specifically, green light), (B) of FIG. 13 illustrates a behavior of second light (specifically, red light), and (C) of FIG. 13 illustrates a behavior of third light (specifically, blue light). The projection-type display device illustrated in FIG. 13 according to Modification 5 of Example 4 further includes:

second changing means 67B, in which

return light of the second light returning from the projection optical system 100 passes through the retardation plate 50, enters the first polarization beam splitter 11, exits the first polarization beam splitter 11 in a direction opposite to the direction in which the first light from the light source entered the first polarization beam splitter 11, enters the second polarization beam splitter 20, exits the second polarization beam splitter 20 in a direction different from the direction in which the first light from the light source exits the second polarization beam splitter 20, and is discarded out of the system. Return light of the third light returning from the projection optical system 100 passes through the retardation plate 50, enters the first polarization beam splitter 11, exits the first polarization beam splitter 11 in a direction opposite to the direction in which the second light and the third light from the light source entered the first polarization beam splitter 11, enters the third polarization beam splitter 30 via the first changing means 63, exits the third polarization beam splitter 30, collides with the second changing means 67B to have the light path of the return light changed by the changing means 67B, or have the wavelength range or the polarization state of the return light changed by the second changing means 67B, or is absorbed by the second changing means 67B. Then, in this case, unlike the first polarization beam splitter 10, the first polarization beam splitter 11 allows the third light in either of the P-polarized state and the S-polarized state to pass therethrough, and allows the first light and the second light in the P-polarized state to pass therethrough but reflects the first light and the second light in the S-polarized state. Furthermore, as illustrated in (C) of FIG. 13, the wavelength-selective retardation plate 73 acts as a half-wave plate not only on the second light but also on the third light to change the polarization state; that is, the wavelength-selective retardation plate 73 may be a simple retardation plate without wavelength selectivity. In the configuration where the first beam splitter 11 that passes the third light in either of the P-polarized state and the S-polarized state is combined with the wavelength-selective retardation plate 73 including the retardation plate having no wavelength selectivity, return light of the third light can be discarded out of the system by the second changing means 67B instead of discarding return light of the third light through a free port.

Alternatively, FIG. 8B shows a conceptual diagram of an alternative projection-type display device according to Modification 6 of Example 4, in which the first changing means that changes the polarization state of return light of the first light includes a quarter-wave plate 68A and a light reflective member 68C that are disposed in the order mentioned from the incident side of return light of the first light. It is preferable that the quarter-wave plate 68A, the light reflective member 68C, and the first polarization beam splitter 10 are integrated, and it is preferable that the quarter-wave plate 68B and the third polarization beam splitter 30 are integrated. A combination of the quarter-wave plate 68A and the quarter-wave plate 68B functions as the third wavelength-selective retardation plate 73. The light reflective member 68C returns return light of the first light, the return light having passed through the quarter-wave plate 68A, to the first polarization beam splitter 10 via the quarter-wave plate 68A, and the first light is discarded out of the system. Furthermore, the second changing means that changes the polarization state of return light of the second light and the third light includes a quarter-wave plate 68D and a light reflective member 68F that are disposed in the order mentioned from the incident side of return light of the second light and the third light. It is preferable that the quarter-wave plate 68D, the light reflective member 68F, and the first polarization beam splitter 10 are integrated, and it is preferable that the quarter-wave plate 68E and the second polarization beam splitter 20 are integrated. A combination of the quarter-wave plate 68D and the quarter-wave plate 68E functions as the first wavelength-selective retardation plate 71. The light reflective member 68F returns return light of the second light and the third light, the return light having passed through the quarter-wave plate 68D, to the first polarization beam splitter 10 via the quarter-wave plate 68D, and the second light and the third light are discarded out of the system. Note that the light reflective member 68C includes a dichroic mirror that transmits the second light and the third light, and the light reflective member 68F includes a dichroic mirror that transmits the first light.

### Example 5

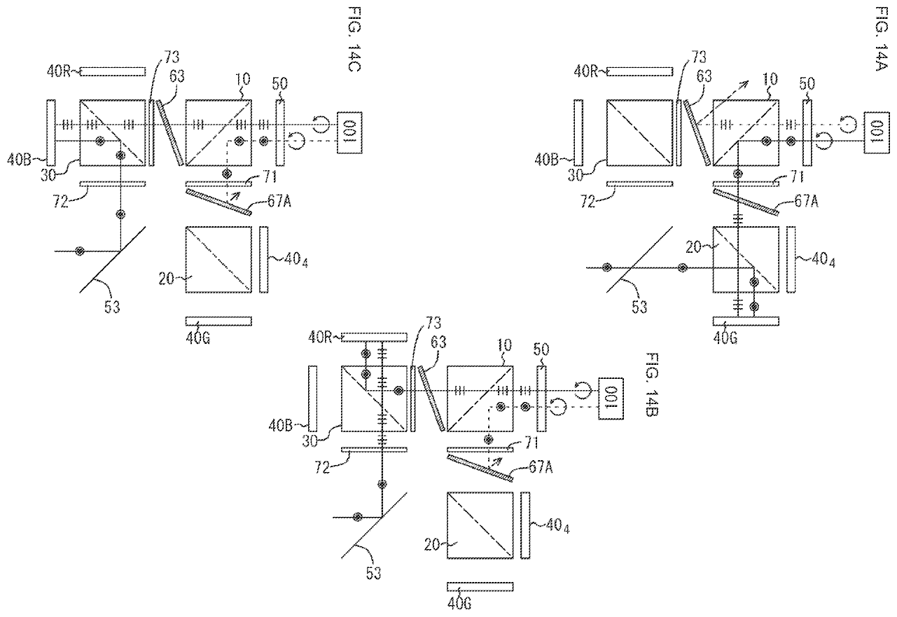

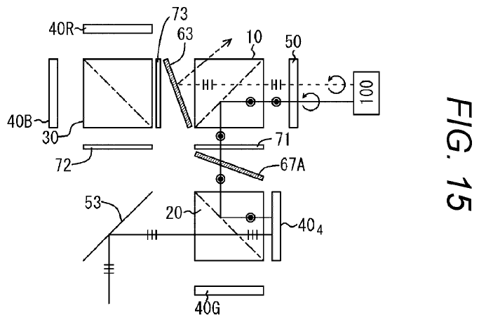

Example 5 is a modification of Example 4, and more specifically, a modification of Modification 4 of Example 4. FIGS. 14 and 15 show conceptual diagrams of the projection-type display device of Example 5; (A) of FIG. 14 illustrates a behavior of first light (specifically, green light), (B) of FIG. 14 illustrates a behavior of second light (specifically, red light), (C) of FIG. 14 illustrates a behavior of third light (specifically, blue light), and FIG. 15 illustrates a behavior of fourth light (specifically, infrared light).

The projection-type display device of Example 5 further includes:

a fourth reflective spatial light modulator 40₄, in which from the light source, fourth light having a fourth wavelength range enters the second polarization beam splitter 20 from the same direction as the direction of the first light, and the fourth light having entered the second polarization beam splitter 20 exits the second polarization beam splitter 20 in a direction different from the direction of the first light, is reflected by the fourth reflective spatial light modulator 40₄, re-enters the first polarization beam splitter 10, re-exits the second polarization beam splitter 20 in the same direction as the direction of the first light, and travels toward the retardation plate 50.

Specifically, the fourth reflective spatial light modulator 40₄ is disposed on a free port of the second polarization beam splitter 20. The fourth reflective spatial light modulator 40₄ controls generation of an infrared image. The observer can recognize an infrared image by using a night vision tool such as night vision goggles. The behavior of the fourth light subsequent to exiting the second polarization beam splitter 20 may be the same as the behavior of the first light.

More specifically, fourth light (specifically, infrared light) from the light source (not illustrated) in the P-polarized state is reflected by the dichroic mirror 53 disposed in the illumination system, enters the second polarization beam splitter 20, passes through the polarization splitting plane, exits the second polarization beam splitter 20 in the P-polarized state, enters the fourth reflective spatial light modulator 40₄, exits the fourth reflective spatial light modulator 40₄ in the S-polarized state, enters the second polarization beam splitter 20 in the S-polarized state, is reflected by the polarization splitting plane, and exits the second polarization beam splitter 20. Then, the light passes through the second changing means 67A and the first wavelength-selective retardation plate 71 while remaining in the S-polarized state, and reaches the first polarization beam splitter 10. In this state, the polarization state of the fourth light is the S-polarized state, and thus the light is reflected by the polarization splitting plane, exits the first polarization beam splitter 10, passes through the retardation plate 50 to reach a circularly polarized state, and travels toward the projection optical system 100. Then, the light is projected from the projection optical system 100 onto the projection surface. At the same time, part of the light returns to the retardation plate 50, as return light caused by interface reflection on a lens or the like inside the projection optical system 100. The return light of the fourth light in a circularly polarized state, the return light having returned from the projection optical system 100 to the retardation plate 50, passes through the retardation plate 50 to go into the P-polarized state, enters the first polarization beam splitter 10, passes through the polarization splitting plane, exits the first polarization beam splitter 10 in a direction different from the direction in which the fourth light entered the first polarization beam splitter 10, collides with the first changing means 63 to have the light path, the wavelength range, or the polarization state of the return light changed by the first changing means 63, and is discarded out of the system.

Note that behaviors of the first light, the second light, and the third light are similar to the behaviors according to Modification 4 of Example 4, and thus detailed description thereof is omitted.

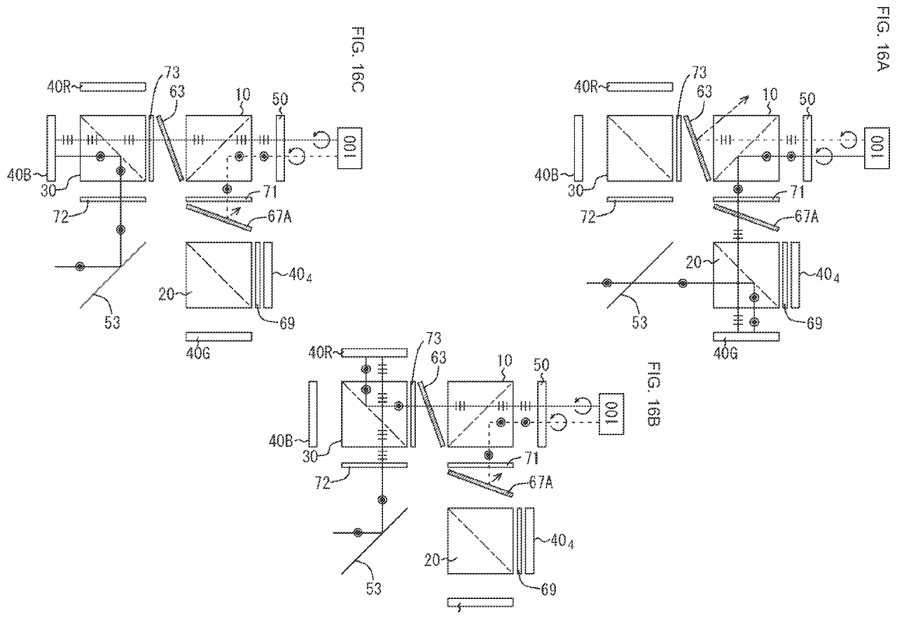

As illustrated in FIG. 16, for example, a third changing means 69 may be disposed between the second polarization beam splitter 20 and the fourth reflective spatial light modulator 40₄. The third changing means 69 has a configuration and structure basically similar to those of the first changing means and the second changing means. By causing the third changing means 69 to act on leaked light in the P-polarized state in the illumination system and on leaked light in the S-polarized state in the second polarization beam splitter 20, a decrease in the native contrast caused by reflection by the fourth reflective spatial light modulator 40₄ can be prevented, and it is easier to design the illumination system and the second polarization beam splitter 20.

In the optical element and the projection-type display device of the present disclosure as described in Examples 1 to 5 above, the changing means (the first changing means) changes the light path, the wavelength range, or the polarization state of light, or first light is absorbed not by a polarizing plate but by a heat absorbing member, whereby heat generation can suppressed to the extent possible.

In addition, ghost light can be reduced and ANSI contrast can be improved. Moreover, the optical element can be reduced in size and, as the optical element is smaller, the back focus can be made shorter, which results in achievement of a smaller projection optical system and a smaller device as a whole. Furthermore, the optical element is enabled to separate color and thus can be applied to an illumination system of a single white-color system, which results in a smaller illumination system. Moreover, the polarization beam splitter has a high transmittance, and thus the system as a whole has a high transmittance, which results in improved efficiency and greater luminance. In addition, since the amount of generated heat is small, the device is suitable for higher durability and higher luminance and the influence of focus drift caused by a thermal lens effect is small. Furthermore, the color purity is made higher and the color gamut can be extended. Moreover, higher native contrast is provided because the polarization axis of the first polarization beam splitter and the second polarization beam splitter is allowed to match the polarization axis of the first polarization beam splitter and the second polarization beam splitter by the wavelength-selective retardation plate.

The present disclosure has been described on the basis of preferred examples, but the present disclosure is not limited to these examples. The positions where various polarization beam splitters and various reflective spatial light modulators are disposed are illustrative examples and may be changed as appropriate depending on the polarization state. In addition, various optical components described above (various polarization beam splitters, various retardation plates, various wavelength-selective retardation plates, various quarter-wave plates, various half-wave plates, various changing means, and various light reflective members) are only needed to be designed taking into consideration the light, the polarization state of the light, and the like related to the optical components.

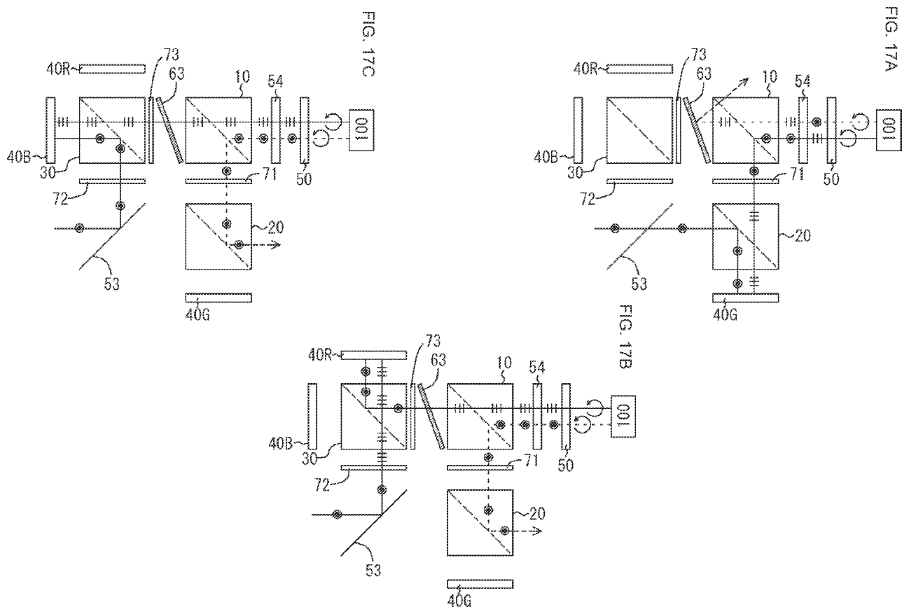

As in FIG. 17 showing conceptual diagrams of the projection-type display device according to Modification 7 of Example 4, a half-wave plate 54 acting on the first light may be disposed between the first polarization beam splitter 10 and the retardation plate 50. As a result, the polarization states of the first light, the second light, and the third light incident on the projection optical system 100 are allowed to coincide with one another. Then, with the coinciding polarization states, it is made possible to improve color uniformity when reflection characteristics of a projection surface are dependent on polarization (for example, when an image or video picture is obliquely incident on a smooth or rough surface where surface scattering is dominant compared with volume scattering) and to support three-dimensional image display. Specifically, the first light exiting the first polarization beam splitter 10 in the S-polarized state passes through the half-wave plate 54 to go into the P-polarized state, the half-wave plate acting on the first light, and passes through the retardation plate 50 to reach a circularly polarized state. Then, the light is projected from the projection optical system 100 onto the projection surface. At the same time, part of the light returns to the retardation plate 50, as return light in the S-polarized state caused by interface reflection on a lens or the like inside the projection optical system 100. Return light of the first light that has passed through the retardation plate 50 and the half-wave plate 54 to go into the P-polarized state enters the first polarization beam splitter 10, passes through the polarization splitting plane, collides with the first changing means 65 to have the light path, the wavelength range, or the polarization state of the return light changed by the first changing means 65, and is discarded out of the system. The polarization states of the second light and the third light passing through the half-wave plate 54 remain unchanged. Note that such half-wave plate 54 may be applied to other examples.

In a case where it is desirable that the light emitted from the projection optical system 100 is in a linearly polarized state rather than in a circularly polarized state, an additional retardation plate may be disposed between the projection optical system 100 and the projection surface.

A depolarizing member may be disposed between the projection optical system and the projection surface. In a case where reflection characteristics of the projection surface are dependent on polarization, depolarization is another effective means for improving the color uniformity. Disposing a depolarizing member beyond (downstream) the projection optical system provides an effect of depolarization while preventing a decrease in the ANSI contrast caused by return light. The depolarizing member includes, for example, a parallel flat plate including a material having birefringence. In a case where the wavelength range is very narrow such as laser light, a wedge-shaped depolarizing member is preferable because a parallel flat plate may have difficulty in providing the effect.

To further improve the ANSI contrast, it is preferable to suppress the interface reflection on each optical component to the extent possible. Specifically, in a case where an anti-reflection coating or an index matching coating is applied to the interface or an adhesive is used on the interface, it is preferable to select an adhesive including a material whose refractive index is close to the refractive index of the adherend.

The present disclosure may have the following configurations.

[A01]<<Optical element: first aspect>>

An optical element including:

a polarization beam splitter; a retardation plate; and changing means, in which

light that has entered the polarization beam splitter from a light source exits the polarization beam splitter and passes through the retardation plate, and

return light that is the light that has passed through the retardation plate and has returned to the retardation plate passes through the retardation plate, enters the polarization beam splitter, exits the polarization beam splitter, and collides with the changing means to have a light path, a wavelength range, or a polarization state of the return light changed by the changing means.

[A02] The optical element according to [A01], in which

the changing means that changes the light path includes a light reflective member that reflects the return light out of a system, a diffractive grating member that releases the return light out of the system, or a holographic optical element that releases the return light out of the system.

[A03] The optical element according to [A02], in which

the changing means includes the light reflective member that reflects the return light out of the system,

the light that has passed through the retardation plate travels toward a projection optical system, and the return light from the projection optical system passes through the retardation plate, and

an incident angle of the return light on a light reflective surface of the changing means is equal to or greater than a cone angle in a medium having an f-number of the projection optical system.

[A04] The optical element according to [A01], in which

the changing means that coverts the wavelength range of the return light includes a fluorescent material layer.

[A05] The optical element according to [A01], in which

the changing means that changes the polarization state of the return light includes a quarter-wave plate and a light reflective member disposed in an order mentioned from an incident side of the return light, and

the light reflective member returns the return light that has passed through the quarter-wave plate to the polarization beam splitter via the quarter-wave plate.

[A06] The optical element according to [A05], in which

the return light that has been returned to the polarization beam splitter by the changing means exits the polarization beam splitter in a direction that is the direction in which the light from the light source enters the polarization beam splitter and that is different from the direction in which the return light that has passed through the retardation plate enters the polarization beam splitter.

[A07] The optical element according to any one of [A01] to [A06], in which

the retardation plate includes a quarter-wave plate.

[B01]<<Projection-type display device>>

A projection-type display device including:

an optical element including a first polarization beam splitter, a retardation plate, and first changing means; and

a first reflective spatial light modulator, in which

first light that has a first wavelength range and that has been emitted from a light source and has entered the first polarization beam splitter via the first reflective spatial light modulator exits the first polarization beam splitter, passes through the retardation plate, and travels toward a projection optical system, and

return light of the first light returning from the projection optical system passes through the retardation plate, enters the first polarization beam splitter, exits the first polarization beam splitter, and collides with the first changing means to have a light path, a wavelength range, or a polarization state of the return light changed by the first changing means.

[B02] The projection-type display device according to [B01], further including:

a second reflective spatial light modulator, in which

from the light source, second light having a second wavelength range enters the first polarization beam splitter from a same direction as the direction of the first light, and

the second light having entered the first polarization beam splitter exits the first polarization beam splitter in a direction different from the direction of the first light, is reflected by the second reflective spatial light modulator, re-enters the first polarization beam splitter, re-exits the first polarization beam splitter in the same direction as the direction of the first light, and travels toward the retardation plate.

[B03] The projection-type display device according to [B01], further including:

a second reflective spatial light modulator and a second polarization beam splitter, in which

the first light from the light source enters the second polarization beam splitter, exits the second polarization beam splitter, is reflected by the first reflective spatial light modulator, re-enters the second polarization beam splitter, re-exits the second polarization beam splitter, and enters the first polarization beam splitter, and

from the light source, second light having a second wavelength range enters the second polarization beam splitter from a same direction as the direction of the first light, exits the second polarization beam splitter in a direction different from the direction of the first light, is reflected by the second reflective spatial light modulator, re-enters the second polarization beam splitter, re-exits the second polarization beam splitter in the same direction as the direction of the first light, and enters the first polarization beam splitter.

[B04] The projection-type display device according to [B01], further including:

a second reflective spatial light modulator, a second polarization beam splitter, and a third polarization beam splitter, in which

the first light from the light source enters the second polarization beam splitter, exits the second polarization beam splitter, is reflected by the first reflective spatial light modulator, re-enters the second polarization beam splitter, re-exits the second polarization beam splitter, and enters the first polarization beam splitter, and

from the light source, second light having a second wavelength range enters the third polarization beam splitter, exits the third polarization beam splitter, is reflected by the second reflective spatial light modulator, re-enters the third polarization beam splitter and enters the first polarization beam splitter via the first changing means, exits the first polarization beam splitter, passes through the retardation plate, and travels toward the projection optical system.

[B05] The projection-type display device according to [B04], further including:

a third reflective spatial light modulator disposed at a position that is adjacent to the third polarization beam splitter and is different from the position of the second reflective spatial light modulator, in which

third light that has a third wavelength range and that has been emitted from the light source and has entered the third polarization beam splitter exits the third polarization beam splitter, is reflected by the third reflective spatial light modulator, re-enters the third polarization beam splitter, re-exits the third polarization beam splitter in a same direction as the direction of the second light, enters the first changing means, passes through the first changing means, the first polarization beam splitter, and the retardation plate, and travels toward the projection optical system.

[B06] The projection-type display device according to [B05], in which

the return light of the second light returning from the projection optical system passes through the retardation plate, enters the first polarization beam splitter, exits the first polarization beam splitter in a direction opposite to the direction in which the first light from the light source entered the first polarization beam splitter, enters the second polarization beam splitter, and exits the first polarization beam splitter in a direction different from the direction in which the first light from the light source exits the first polarization beam splitter.

[B07] The projection-type display device according to [B05], in which

the return light of the second light returning from the projection optical system passes through the retardation plate, enters the first polarization beam splitter, exits the first polarization beam splitter in a direction opposite to the direction in which the first light from the light source entered the first polarization beam splitter, collides with second changing means, is returned to the first polarization beam splitter by the second changing means, and exits the first polarization beam splitter in a direction different from the direction in which the return light of the second light entered the first polarization beam splitter.

[B08] The projection-type display device according to [B05], in which

the return light of the second light returning from the projection optical system passes through the retardation plate, enters the first polarization beam splitter, exits the first polarization beam splitter in a direction opposite to the direction in which the first light from the light source entered the first polarization beam splitter, collides with second changing means to have a light path of the return light changed by the second changing means, or to have a wavelength range or a polarization state of the return light changed by the second changing means, or to be absorbed.

[B09] The projection-type display device according to [B05], further including:

a fourth reflective spatial light modulator, in which

from the light source, fourth light having a fourth wavelength range enters the second polarization beam splitter from a same direction as the direction of the first light, and the fourth light having entered the second polarization beam splitter exits the second polarization beam splitter in a direction different from the direction of the first light, is reflected by the fourth reflective spatial light modulator, re-enters the first polarization beam splitter, re-exits the second polarization beam splitter in the same direction as the direction of the first light, and travels toward the retardation plate.

[B10] The projection-type display device according to any one of [B01] to [B09], in which

a half-wave plate acting on the first light is disposed between the first polarization beam splitter and the retardation plate.

[B11] The projection-type display device according to any one of [B01] to [B10], in which

the first changing means that changes the light path includes a light reflective member that reflects the return light out of a system, a diffractive grating member that releases the return light out of the system, or a holographic optical element that releases the return light out of the system.

[B12] The projection-type display device according to [B11], in which

the first changing means includes the light reflective member that reflects the return light out of the system,

the light that has passed through the retardation plate travels toward the projection optical system, and the return light from the projection optical system passes through the retardation plate, and

an incident angle of the return light on a light reflective surface of the first changing means is equal to or greater than a cone angle in a medium having an f-number of the projection optical system.

[B13] The projection-type display device according to any one of [B01] to [B10], in which

the first changing means that converts the wavelength range of the return light includes a fluorescent material layer.

[B14] The projection-type display device according to any one of [B01] to [B10], in which

the first changing means that changes the polarization state of the return light includes a quarter-wave plate and a light reflective member disposed in an order mentioned from an incident side of the return light, and

the light reflective member returns the return light that has passed through the quarter-wave plate to the first polarization beam splitter via the quarter-wave plate.

[B15] The projection-type display device according to [B14], in which

the return light that has been returned to the first polarization beam splitter by the first changing means exits the first polarization beam splitter in a direction that is the direction in which the light from the light source enters the first polarization beam splitter and that is different from the direction in which the return light that has passed through the retardation plate enters the first polarization beam splitter.

[B16] The projection-type display device according to any one of [B01] to [B15], in which

the retardation plate includes a quarter-wave plate.

[C01]<<Optical element: second aspect>>

An optical element including:

a polarization beam splitter; a retardation plate; and changing means, in which

light that has entered the polarization beam splitter from a light source exits the polarization beam splitter and passes through the retardation plate, and

return light that is the light that has passed through the retardation plate and has returned to the retardation plate passes through the retardation plate, enters the polarization beam splitter, exits the polarization beam splitter, and is absorbed by a heat absorbing member.

### REFERENCE SIGNS LIST

10, 11 Polarization beam splitter (first polarization beam splitter)
20 Second polarization beam splitter
30 Third polarization beam splitter
40G First reflective spatial light modulator
40R, 40B Second reflective spatial light modulator in Examples 2 and 3
40R Second reflective spatial light modulator in Examples 4 and 5
40B Third reflective spatial light modulator
40₄ Fourth reflective spatial light modulator
50 Retardation plate
51 Half-wave plate
52 Wavelength-selective retardation plate
53 Dichroic mirror
54 Half-wave plate acting on first light
60, 60A, 60B Changing means
60C Quarter-wave plate included in changing means
60D Light reflective member included in changing means
60E Quarter-wave plate
61 Light reflective surface on changing means
62 Wedge-shaped prism
63, 65 First changing means
63A, 63B Wedge-shaped prism
64, 66, 67A, 67B Second changing means
68A Quarter-wave plate included in first changing means
68B Quarter-wave plate
68C Light reflective member included in first changing means
68D Quarter-wave plate included in second changing means
68E Quarter-wave plate
68F Light reflective member included in second changing means
69 Third changing means
71 First wavelength-selective retardation plate
72 Second wavelength-selective retardation plate
73 Third wavelength-selective retardation plate
74 Fourth wavelength-selective retardation plate
100 Projection optical system
75 Light reflective member
76 Fifth wavelength-selective retardation plate

1. An optical element comprising:
a polarization beam splitter; a retardation plate; and changing means, wherein
light that has entered the polarization beam splitter from a light source exits the polarization beam splitter and passes through the retardation plate, and
return light that is the light that has passed through the retardation plate and has returned to the retardation plate passes through the retardation plate, enters the polarization beam splitter, exits the polarization beam splitter, and collides with the changing means to have a light path, a wavelength range, or a polarization state of the return light changed by the changing means.

2. The optical element according to claim 1, wherein
the changing means that changes the light path includes a light reflective member that reflects the return light out of a system, a diffractive grating member that releases the return light out of the system, or a holographic optical element that releases the return light out of the system.

3. The optical element according to claim 2, wherein
the changing means includes the light reflective member that reflects the return light out of the system,
the light that has passed through the retardation plate travels toward a projection optical system, and the return light from the projection optical system passes through the retardation plate, and
an incident angle of the return light on a light reflective surface of the changing means is equal to or greater than a cone angle in a medium having an f-number of the projection optical system.

4. The optical element according to claim 1, wherein
the changing means that coverts the wavelength range of the return light includes a fluorescent material layer.

5. The optical element according to claim 1, wherein
the changing means that changes the polarization state of the return light includes a quarter-wave plate and a light reflective member disposed in an order mentioned from an incident side of the return light, and
the light reflective member returns the return light that has passed through the quarter-wave plate to the polarization beam splitter via the quarter-wave plate.

6. The optical element according to claim 5, wherein
the return light that has been returned to the polarization beam splitter by the changing means exits the polarization beam splitter in a direction that is the direction in which the light from the light source enters the polarization beam splitter and that is different from the direction in which the return light that has passed through the retardation plate enters the polarization beam splitter.

7. The optical element according to claim 1, wherein
the retardation plate includes a quarter-wave plate.

8. A projection-type display device comprising:
an optical element including a first polarization beam splitter, a retardation plate, and first changing means; and
a first reflective spatial light modulator, wherein
first light that has a first wavelength range and that has been emitted from a light source and has entered the first polarization beam splitter via the first reflective spatial light modulator exits the first polarization beam splitter, passes through the retardation plate, and travels toward a projection optical system, and
return light of the first light returning from the projection optical system passes through the retardation plate, enters the first polarization beam splitter, exits the first polarization beam splitter, and collides with the first changing means to have a light path, a wavelength range, or a polarization state of the return light changed by the first changing means.

9. The projection-type display device according to claim 8, further comprising:
a second reflective spatial light modulator, wherein
from the light source, second light having a second wavelength range enters the first polarization beam splitter from a same direction as the direction of the first light, and
the second light having entered the first polarization beam splitter exits the first polarization beam splitter in a direction different from the direction of the first light, is reflected by the second reflective spatial light modulator, re-enters the first polarization beam splitter, re-exits the first polarization beam splitter in the same direction as the direction of the first light, and travels toward the retardation plate.

10. The projection-type display device according to claim 8, further comprising:
a second reflective spatial light modulator and a second polarization beam splitter, wherein
the first light from the light source enters the second polarization beam splitter, exits the second polarization beam splitter, is reflected by the first reflective spatial light modulator, re-enters the second polarization beam splitter, re-exits the second polarization beam splitter, and enters the first polarization beam splitter, and
from the light source, second light having a second wavelength range enters the second polarization beam splitter from a same direction as the direction of the first light, exits the second polarization beam splitter in a direction different from the direction of the first light, is reflected by the second reflective spatial light modulator, re-enters the second polarization beam splitter, re-exits the second polarization beam splitter in the same direction as the direction of the first light, and enters the first polarization beam splitter.

11. The projection-type display device according to claim 8, further comprising:
a second reflective spatial light modulator, a second polarization beam splitter, and a third polarization beam splitter, wherein
the first light from the light source enters the second polarization beam splitter, exits the second polarization beam splitter, is reflected by the first reflective spatial light modulator, re-enters the second polarization beam splitter, re-exits the second polarization beam splitter, and enters the first polarization beam splitter, and
from the light source, second light having a second wavelength range enters the third polarization beam splitter, exits the third polarization beam splitter, is reflected by the second reflective spatial light modulator, re-enters the third polarization beam splitter and enters the first polarization beam splitter via the first changing means, exits the first polarization beam splitter, passes through the retardation plate, and travels toward the projection optical system.

12. The projection-type display device according to claim 11, further comprising:
a third reflective spatial light modulator disposed at a position that is adjacent to the third polarization beam splitter and is different from the position of the second reflective spatial light modulator, wherein
third light that has a third wavelength range and that has been emitted from the light source and has entered the third polarization beam splitter exits the third polarization beam splitter, is reflected by the third reflective spatial light modulator, re-enters the third polarization beam splitter, re-exits the third polarization beam splitter in a same direction as the direction of the second light, enters the first changing means, passes through the first changing means, the first polarization beam splitter, and the retardation plate, and travels toward the projection optical system.

13. The projection-type display device according to claim 12, wherein
the return light of the second light returning from the projection optical system passes through the retardation plate, enters the first polarization beam splitter, exits the first polarization beam splitter in a direction opposite to the direction in which the first light from the light source entered the first polarization beam splitter, enters the second polarization beam splitter, and exits the first polarization beam splitter in a direction different from the direction in which the first light from the light source exits the first polarization beam splitter.

14. The projection-type display device according to claim 12, wherein
the return light of the second light returning from the projection optical system passes through the retardation plate, enters the first polarization beam splitter, exits the first polarization beam splitter in a direction opposite to the direction in which the first light from the light source entered the first polarization beam splitter, collides with second changing means, is returned to the first polarization beam splitter by the second changing means, and exits the first polarization beam splitter in a direction different from the direction in which the return light of the second light entered the first polarization beam splitter.

15. The projection-type display device according to claim 12, wherein
the return light of the second light returning from the projection optical system passes through the retardation plate, enters the first polarization beam splitter, exits the first polarization beam splitter in a direction opposite to the direction in which the first light from the light source entered the first polarization beam splitter, collides with second changing means to have a light path of the return light changed by the second changing means, or to have a wavelength range or a polarization state of the return light changed by the second changing means, or to be absorbed.

16. The projection-type display device according to claim 12, further comprising:
a fourth reflective spatial light modulator, wherein
from the light source, fourth light having a fourth wavelength range enters the second polarization beam splitter from a same direction as the direction of the first light, and the fourth light having entered the second polarization beam splitter exits the second polarization beam splitter in a direction different from the direction of the first light, is reflected by the fourth reflective spatial light modulator, re-enters the first polarization beam splitter, re-exits the second polarization beam splitter in the same direction as the direction of the first light, and travels toward the retardation plate.

17. The projection-type display device according to claim 8, wherein
a half-wave plate acting on the first light is disposed between the first polarization beam splitter and the retardation plate.

18. An optical element comprising:
a polarization beam splitter; a retardation plate; and changing means, wherein
light that has entered the polarization beam splitter from a light source exits the polarization beam splitter and passes through the retardation plate, and
return light that is the light that has passed through the retardation plate and has returned to the retardation plate passes through the retardation plate, enters the polarization beam splitter, exits the polarization beam splitter, and is absorbed by a heat absorbing member.
